(19) United States
(12) Patent Application Publication
(10) Pub. No.: US 2025/0211894 A1
(43) Pub. Date: Jun. 26, 2025

(54) SOUND SYSTEM AND VEHICLE

(71) Applicant: NIPPON TELEGRAPH AND TELEPHONE CORPORATION, Tokyo (JP)

(72) Inventors: Masahiro FUKUI, Tokyo (JP); Kazunori KOBAYASHI, Tokyo (JP); Noriyoshi KAMADO, Tokyo (JP); Yohei WAKISAKA, Tokyo (JP)

(73) Assignee: NIPPON TELEGRAPH AND TELEPHONE CORPORATION, Tokyo (JP)

(21) Appl. No.: 18/849,002

(22) PCT Filed: Mar. 28, 2022
(86) PCT No.: PCT/JP2022/014994

§ 371 Date: Sep. 20, 2024

(51) Int. Cl. H04R 1/32; H04S 7/00

(52) U.S. Cl. CPC H04R 1/323; H04S 7/302; H04R 2499/13

(57) ABSTRACT

A sound system capable of reproducing a sound that cannot be heard by surrounding users without using the earphone or the headphone is provided. A sound system has at least two speaker unit pairs that includes a positive speaker including no speaker box and a negative speaker including no speaker box, and includes a selection unit that selects any one speaker unit pair in accordance with a position of an user's auditory organ and a position of the speaker unit pair, and a control unit that controls to emit an acoustic signal (hereinafter referred to as a first acoustic signal) of a predetermined sound source only from the positive speaker of the selected speaker unit pair, and to emit an acoustic signal (hereinafter referred to as a second acoustic signal) having an opposite phase to that of the first acoustic signal only from the negative speaker of the selected speaker unit pair.

### TECHNICAL FIELD

The present invention relates to a sound localized reproduction technique.

### BACKGROUND ART

Conventionally, a user has utilized an earphone or a headphone in order to view a movie or music in an aircraft (see NPL 1). This is because, when a speaker is used, a reproduced sound reaches a periphery of the user, and causes trouble to other users.

### CITATION LIST

### Non Patent Literature

[NPL 1] Entertainment in an aircraft/JAL first class, [online], [retrieved on Feb. 1, 2021], the Internet <URL: https://www.jal.co.jp/jp/ja/inter/service/first/entertainment/index.html>

### SUMMARY OF INVENTION

### Technical Problem

However, wearing of the earphone or the headphone is troublesome for the user. Also, some users do not like to wear them because they disrupt their hairstyle. Some users dislike pressure on ears caused by wearing them. There are cases where a headphone of an appropriate size cannot be selected like a child, and wearing of the earphone or the headphone itself is difficult like a baby.

In order to eliminate the need for wearing the earphone or the headphone, it is conceivable to synthesize a virtual sound field by using a wave field synthesis technique, but in this case, it is necessary to prepare a large-scale speaker array, which is not realistic.

In addition, when localized emission is performed so that other users cannot hear, an appropriate region cannot be made an audible region unless a speaker arrangement is made different depending on an object to be mounted.

Therefore, in the present invention, it is an object to provide a sound system capable of reproducing a sound that cannot be heard by surrounding users without using the earphone or the headphone.

### Solution to Problem

In an aspect of the present invention, a sound system has at least two speaker unit pairs that includes a positive speaker including no speaker box and a negative speaker including no speaker box, and includes a selection unit that selects any one speaker unit pair in accordance with a position of a user's auditory organ and a position of the speaker unit pair, and a control unit that controls to emit an acoustic signal (hereinafter referred to as a first acoustic signal) of a predetermined sound source only from the positive speaker of the selected speaker unit pair, and to emit an acoustic signal (hereinafter referred to as a second acoustic signal) having an opposite phase to that of the first acoustic signal only from the negative speaker of the selected speaker unit pair.

In an aspect of the present invention, a sound system has at least three speakers including no speaker box, and includes a selection unit that selects any two speakers in accordance with a position of a user's auditory organ and a position of the speaker, and a control unit that controls to emit an acoustic signal (hereinafter referred to as a first acoustic signal) of a predetermined sound source only from the selected one speaker, and to emit an acoustic signal (hereinafter referred to as a second acoustic signal) having an opposite phase to that of the first acoustic signal only from the selected other speaker.

In an aspect of the present invention, a vehicle is ridden by a human and moves its position by turning wheels driven by human power or electric power. The vehicle includes a directivity control device that includes at least one directivity control unit that executes predetermined signal processing giving directivity to a sound emitted by a speaker unit pair to generate a first processed acoustic signal from an acoustic signal (hereinafter referred to as a first acoustic signal) of a predetermined sound source and to generate a second processed acoustic signal from an acoustic signal (hereinafter referred to as a second acoustic signal) having an opposite phase to that of the first acoustic signal, a speaker system that includes at least one speaker unit pair that includes a speaker (hereinafter referred to as a positive speaker) not including a speaker box and emitting a sound based on the first processed acoustic signal and a speaker (hereinafter referred to as a negative speaker) not including a speaker box and emitting a sound based on the second processed acoustic signal, and a position acquisition unit that acquires a position where a user's auditory organ exists or a position where the speaker unit pair exists and selects a filter in which directivity of a sound emitted by the speaker unit pair is directed to the acquired position where the user's auditory organ exists, wherein the directivity control device performs predetermined signal processing by using the selected filter.

### Advantageous Effects of Invention

According to the present invention, it is possible to reproduce a sound that can be heard only in a very limited narrow range.

### BRIEF DESCRIPTION OF DRAWINGS

FIG. 1 is a diagram for explaining directivity of a sound emitted from a speaker.

FIG. 2 is a diagram for explaining directivity of a sound emitted from a speaker unit.

FIG. 3 is a diagram for explaining a sound emitted from a speaker unit pair.

FIG. 4 is a diagram for explaining directivity of the sound emitted from the speaker unit pair.

FIG. 5 is a diagram showing a situation of experiment (positional relationship between a speaker and a microphone).

FIG. 6 is a diagram showing a situation of experiment (positional relationship between a speaker unit and a microphone).

FIG. 7 is a diagram showing a situation of experiment (positional relationship between a speaker unit pair and a microphone).

FIG. 8 is a diagram showing a situation of experiment (other measurement points).

FIG. 9 is a diagram showing experiment results (condition 1).

FIG. 10 is a diagram showing experiment results (condition 2).

FIG. 11 is a diagram showing experiment results (condition 3).

FIG. 12 is a diagram showing experiment results (condition 4).

FIG. 13 is a diagram showing an example of a sound system installed in a seat of an aircraft.

FIG. 14 is a block diagram showing an example of a configuration of a sound system 100.

FIG. 15 is a diagram showing a situation of the sound emitted from the speaker unit pair.

FIG. 16 is a block diagram showing an example of a configuration of a sound system 200.

FIG. 17 is a block diagram showing an example of a configuration of a sound system 202.

FIG. 18 is a diagram showing an example of a configuration of a speaker unit pair 122 to which a member 1224 is attached.

FIG. 19 is a diagram showing an example of a sound system installed in a seat of an automobile.

FIG. 20 is a diagram showing an example of the sound system installed in the seat of the automobile.

FIG. 21 is a diagram showing an example of a sound system installed on a screen.

FIG. 22 is a block diagram showing an example of a configuration of a sound system 300.

FIG. 23 is a diagram for explaining directivity of a sound emitted from a speaker unit pair.

FIG. 24 is a diagram for explaining the directivity of the sound emitted from the speaker unit pair.

FIG. 25 is a diagram for explaining the directivity of the sound emitted from the speaker unit pair.

FIG. 26 is a diagram for explaining the directivity of the sound emitted from the speaker unit pair.

FIG. 27 is a diagram showing an example of a sound system installed on a screen.

FIG. 28 is a diagram for explaining the directivity of the sound emitted from the speaker unit pair.

FIG. 29 is a block diagram showing an example of a configuration of a sound system 400.

FIG. 30 is a diagram showing an example of a sound system installed on a screen.

FIG. 31 is a diagram showing an example of the sound system installed on the screen.

FIG. 32 is a block diagram showing an example of a configuration of a sound system 500.

FIG. 33 is a diagram for explaining directivity of a sound emitted from the speaker unit pair.

FIG. 34 is a diagram for explaining the directivity of the sound emitted from the speaker unit pair.

FIG. 35 is a diagram showing an example of a sound system installed on a screen.

FIG. 36 is a block diagram showing an example of a configuration of a sound system 600.

FIG. 37 is a diagram showing an example of a sound system installed in a vehicle.

FIG. 38 is a diagram showing an example of the sound system installed in the vehicle.

FIG. 39 is a diagram showing an example of the sound system installed in the vehicle.

FIG. 40 is a diagram showing an example of the sound system installed in the vehicle.

FIG. 41 is a block diagram showing an example of a configuration of a sound system 700.

FIG. 42 is a diagram showing an example of a sound system installed in a vehicle.

### DESCRIPTION OF EMBODIMENTS

The following describes embodiments of the present invention in detail. Note that components having the same function will be denoted by the same reference numerals and redundant description thereof will be omitted.

### Technical Background

First, directivity of a sound emitted from a speaker will be described. Next, the directivity of the sound emitted from the speaker unit pair according to the present invention of the application will be described. Finally, results of experiments for confirming effects of the speaker unit pair according to the present invention of the application will be described.

### 1: Directivity of Sound Emitted from Speaker

Usually, the speaker is composed of a speaker unit and a speaker box. The speaker unit is a component that includes a diaphragm that converts acoustic signals, which are electric signals, into air vibrations (that is, generates sound waves). In addition, the speaker box is a component that houses the speaker unit.

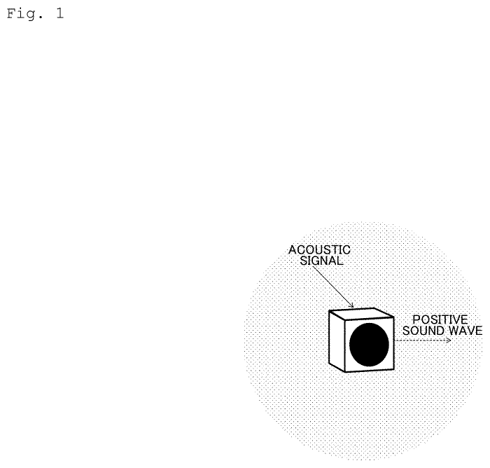

When the acoustic signal is inputted to the speaker, the diaphragm of the speaker unit vibrates, and sound waves are radiated in both directions in which the diaphragm vibrates. Here, the sound wave radiated to the outside of the speaker box (that is, the front direction of the speaker unit) is referred to as a positive sound wave, and the sound wave radiated to the inside of the speaker box (that is, the back direction of the speaker unit) is referred to as a negative sound wave. The negative sound wave is a sound wave that has an opposite phase to that of the positive sound wave. FIG. 1 is a diagram for explaining the directivity of the sound emitted from the speaker. As shown in FIG. 1, the positive sound wave is radiated from the speaker in all directions, while the negative sound wave is not radiated to the outside of the speaker box. As a result, the sound emitted from the speaker can be heard over a wide range.

### 2: Directivity of Sound Emitted from Speaker Unit Pair

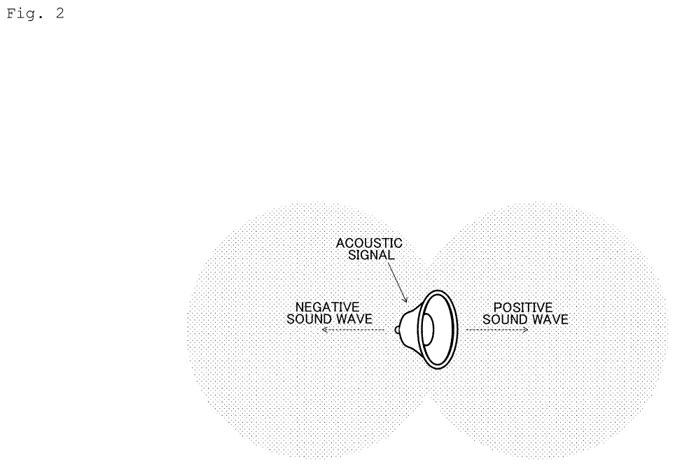

Here, the directivity of the sound emitted from the speaker unit which is a bare speaker will be described first. FIG. 2 is a diagram for explaining an example of the directivity of the sound emitted from the speaker unit. In the case of only the speaker unit, the negative sound wave is radiated from a back of the speaker unit hidden in the speaker box differently from the case of the speaker. Therefore, as shown in FIG. 2, the sound emitted from the speaker unit has a characteristic of bi-directivity.

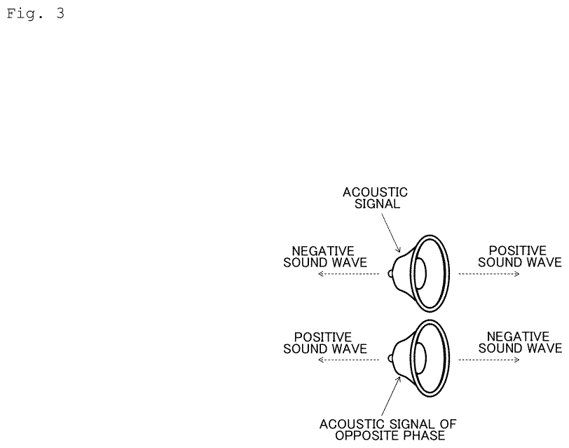

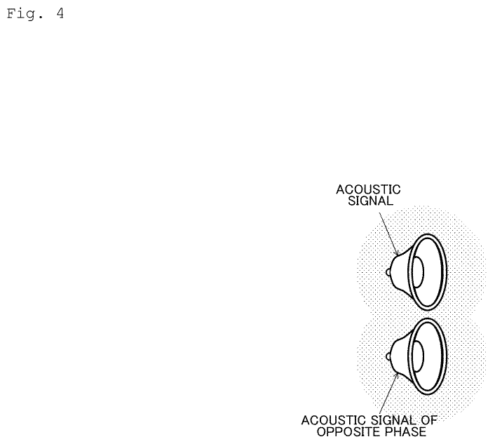

In the present invention of the application, the bi-directivity is utilized. This is described specifically hereinafter. First, as shown in FIG. 3, two speaker units are arranged to form a speaker unit pair. The two speaker units are arranged so as to emit the sound in substantially the same direction. When acoustic signals having the same size and opposite phase relation are inputted to the speaker unit pair respectively, the diaphragms of the two speaker units are vibrated respectively, and sounds based on the two acoustic signals are emitted. Then, the sound released from the speaker unit pair is suppressed largely in all directions except a vicinity of the speaker unit pair, and the sound pressure approaches 0 as much as possible. For example, in FIG. 4, the sound is not erased in a point region in the vicinity of the speaker unit, but a state in which the sound cannot be heard is created outside the point region. That is, the sound is erased only at a position sufficiently distant from the speaker unit pair, and the sound is not erased in the vicinity of the speaker unit pair. The reason why the sound is not erased in the vicinity of the speaker unit pair is that when the sound waves released from each of the speaker unit pair are overlapped at an observation point, influence of a distance based on an arrival route from each speaker unit to the observation point is large. Although the effect of canceling the phase by overlapping the positive and negative directions is obtained at the far distance where the influence of the route difference due to the interval and the wraparound of the speaker unit pair is small, the route difference to an arrival between the sound wave radiated from the front of the speaker unit and the sound wave sneaking from the back is large in the vicinity of the speaker unit pair, and the positive and negative of the phases do not overlap in an exact opposite relation.

That is, when a predetermined acoustic signal is inputted to one speaker unit constituting the speaker unit pair and an acoustic signal having an opposite phase to that of the predetermined acoustic signal is inputted to the other speaker unit, it is possible to create a situation in which only a user in the vicinity of the speaker unit pair can hear and other users cannot hear the sound by utilizing a characteristic in which the sound can be heard in the vicinity of the speaker unit pair.

### 3: Experiment Result

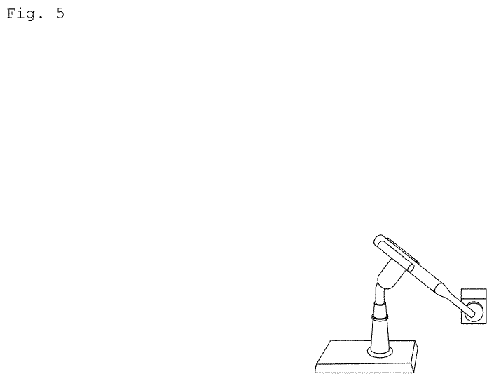

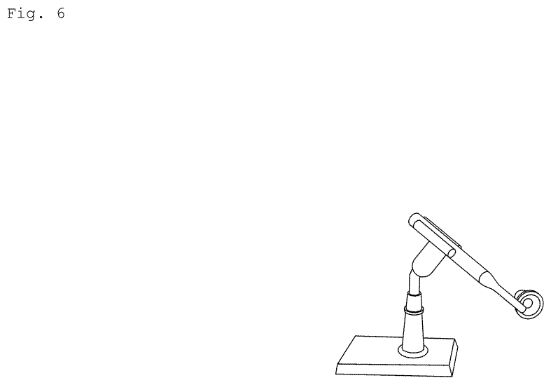

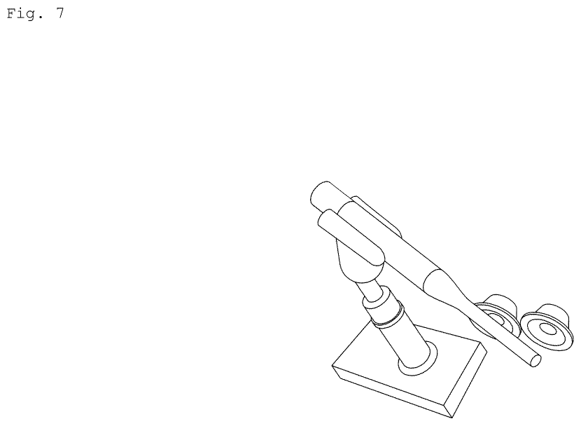

Here, results of experiments that measure frequency characteristics of the speaker, the speaker unit, and the speaker unit pair will be described. In the experiment, as the speaker, the speaker unit, and the speaker unit pair, a speaker having a diaphragm of 4.5 cm in a diameter (see FIG. 5), a speaker unit in which the speaker box is removed from the speaker (see FIG. 6), and a speaker unit pair in which two speaker units are arranged (see FIG. 7) are used. In addition, in order to measure the frequency characteristics in the vicinity of the speaker, the speaker unit, and the speaker unit pair, a microphone is installed under the following four conditions.
(Condition 1) a position of 5 cm from the front of the speaker
(Condition 2) a position of 5 cm from the front of the speaker unit
(Condition 3) a position of 2 cm from the front of the speaker unit
(Condition 4) a position of 2 cm from the front of the speaker unit pair

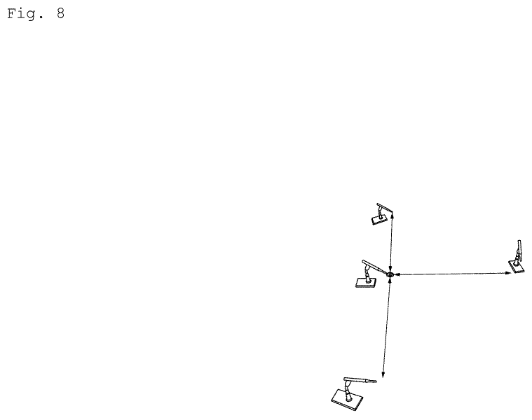

Also, for each of the conditions, for comparison, microphones are also installed at positions of 100 cm from each of the front, back, and side of the speaker, the speaker unit, and the speaker unit pair (see FIG. 8).

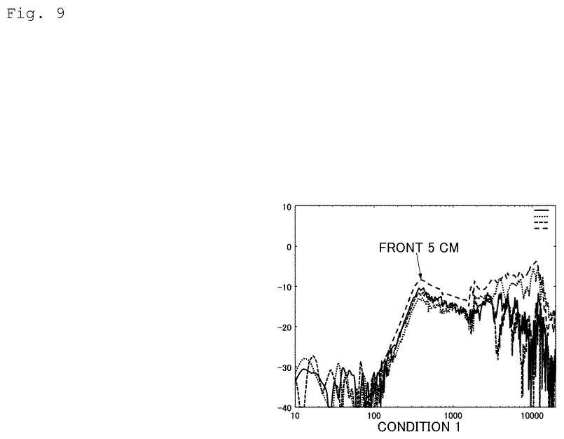

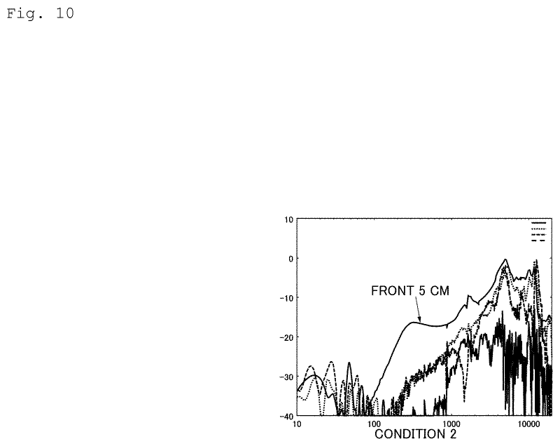

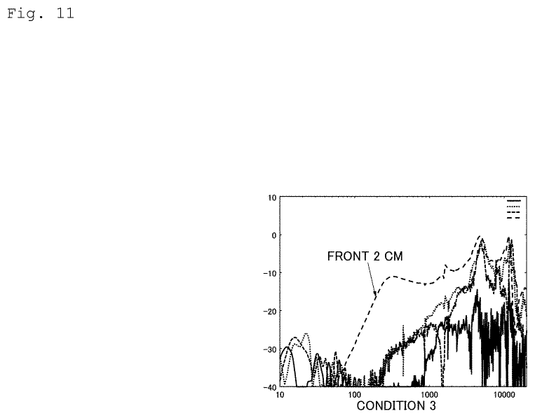

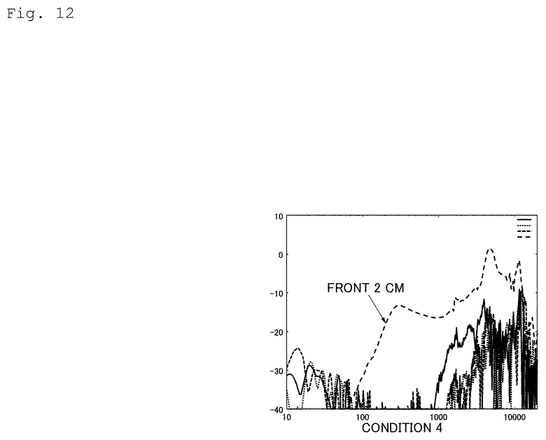

Hereinafter, the experiment results will be described. FIG. 9, FIG. 10, FIG. 11 and FIG. 12 are diagrams showing the experiment results, and showing relationships between the frequency and the attenuation under the condition 1, condition 2, condition 3, and condition 4, respectively. In all figures, four curves are shown, one curve indicated by an arrow is the experiment result in which the sound is collected by a microphone located at a position of 5 cm or 2 cm from the front, and other three curves are the experiment results in which the sounds are collected by the microphones located at a position of 100 cm from the front, the back, and the side. Note that since the curve at the position of 5 cm or 2 cm from the front is located in the vicinity of the speaker or the like, the gain becomes very large. Therefore, in order to make it easy to see, the curve at the position of 5 cm from the front is plotted by −25 dB from three curves at the position of 100 cm. Similarly, the curve at 2 cm from the front is plotted at −32 dB. Comparing FIG. 9 and FIG. 10, it can be seen that there is almost no difference between the four curves when the speaker is used, and there is a difference between the curve at the position of 5 cm from the front and other three curves when the speaker unit is used. This difference is more remarkable as it is in a lower region. Also, comparing FIG. 11 and FIG. 12, it can be seen that the speaker unit pair has a larger difference between the curve at the position of 2 cm from the front and other three curves than that of the speaker unit.

As described above, it was confirmed by the experiments that the sound emitted from the speaker unit pair according to the present invention of the application was heard only in the vicinity of the speaker unit pair.

### First Embodiment

A system that reproduces an acoustic signal obtained based on a reproduction object is called a sound system. The sound system includes a speaker system in order to emit the acoustic signal as the sound (hereinafter, this sound is referred to as a sound based on the acoustic signal). Here, the speaker system is a device that converts the acoustic signal, which is an analogue signal, into the sound. In addition, the reproduction objects are data and signal in which the acoustic signal can be obtained by the predetermined processing, for example, such as data recorded in a CD, a DVD, and a record, data received by the Internet, and signals received by radio broadcasting and television broadcasting.

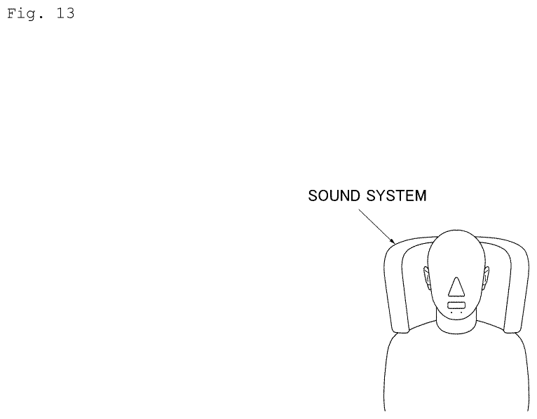

Here, the sound system in which the sound based on the acoustic signal obtained from the reproduction objects is reproduced so as to be heard only by a user in the vicinity of the speaker system will be described. That is, the reproduced sound of the sound system is not heard by users other than the user in the vicinity of the speaker system. When such a sound system is used as a sound system for a user who uses a seat of an aircraft, for example, a system can be provided which allows only the user who uses the seat to hear the reproduced sound. FIG. 13 is a diagram showing an example of the sound system installed in the seat of the aircraft. The sound system shown in FIG. 13 is installed on the seat so as to sandwich a seated user's head, and two speaker unit pairs are arranged in the vicinity of the left and right ears. Note that such a sound system can be installed in a vehicle other than the aircraft such as an automobile and an electric train, or a reclining chair, and it can be installed even in a wearable form such as putting on a shoulder. Further, a driver unit pair, which corresponds to the speaker unit pair and is formed by arranging two driver units, may be installed in the left and right units of a headphone and an earphone. The headphones are generally divided into two types of open type (open air type) and closed type (closed type), but it is expected that sound leakage is reduced if the above-mentioned technique is applied to the open type having a risk of sound leakage.

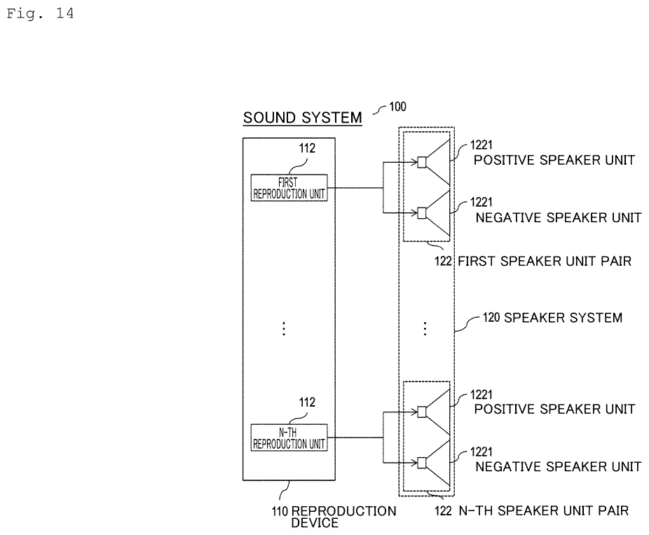

Hereinafter, a sound system 100 will be described with reference to FIG. 14. FIG. 14 is a block diagram showing a configuration of the sound system 100. As shown in FIG. 14, the sound system 100 includes a reproduction device 110 and a speaker system 120. The reproduction device 110 includes N pieces (where N is an integer of 1 or more) of reproduction units 112 (that is, a first reproduction unit 112, and an N-th reproduction unit 112). Further, the speaker system 120 includes N pieces of speaker unit pairs 122 (that is, a first speaker unit pair 122, . . . and an N-th speaker unit pair 122). The speaker unit pair 122 includes two speaker units (that is, a positive speaker unit 1221 and a negative speaker unit 1221). The negative speaker unit 1221 inputs the acoustic signal having an opposite phase to that of the acoustic signal inputted to the positive speaker unit 1221. The speaker system 120 is installed at a place near a head of the user who uses the seat.

Note that the direction in which the n-th speaker unit pair 122 faces the user is defined as an n-th user direction (n=1, . . . , N), and the positive speaker unit 1221 and the negative speaker unit 1221 of the n-th speaker unit pair 122 (n=1, . . . , N) are arranged so that the sound emitted in the opposite direction to the n-th user direction from the positive speaker unit 1221 and the sound emitted in the opposite direction to the n-th user direction from the negative speaker unit 1221 are transmitted in the n-th user direction by the wraparound. Here, the n-th user direction is the front direction of the positive speaker unit 1221 and the negative speaker unit 1221 of the n-th speaker unit pair 122. In addition, the opposite direction to the n-th user direction is the back direction of the positive speaker unit 1221 and the negative speaker unit 1221 of the n-th speaker unit pair 122.

Further, the positive speaker unit 1221 and the negative speaker unit 1221 of the n-th speaker unit pair 122 (n=1, . . . , N) are arranged in a positional relationship in which the sound emitted from the positive speaker unit 1221 and the sound emitted from the negative speaker unit 1221 are erased from each other so that a user who uses another seat cannot hear the sound.

Hereinafter, in accordance with FIG. 14, operations of the sound system 100 will be described.

The reproduction device 110 inputs a first acoustic signal, a third acoustic signal, . . . and a 2N−1-th acoustic signal which are acoustic signals obtained based on the reproduction objects, and outputs the first acoustic signal, the second acoustic signal, . . . , and the 2N-th acoustic signal. More specifically, an n-th reproduction unit 112 (n=1, . . . , N) inputs a 2n−1-th acoustic signal, generates a 2n-th acoustic signal which is an acoustic signal having an opposite phase to that of the 2n−1-th acoustic signal from the 2n−1-th acoustic signal, and outputs the 2n−1-th acoustic signal and the 2n-th acoustic signal. The 2n−1-th acoustic signal and the 2n-th acoustic signal are respectively inputted to the positive speaker unit 1221 and the negative speaker unit 1221 of the n-th speaker unit pair 122.

The speaker system 120 inputs the first acoustic signal, the second acoustic signal, . . . , and the 2N-th acoustic signal outputted by the reproduction device 110, and emits a sound based on the first acoustic signal, a sound based on the second acoustic signal, . . . , and a sound based on the 2N-th acoustic signal. More specifically, the n-th speaker unit pair 122 (n=1, . . . , N) inputs the 2n−1-th acoustic signal and the 2n-th acoustic signal, and emits the sound based on the 2n−1-th acoustic signal from the positive speaker unit 1221, and emits the sound based on the 2n-th acoustic signal from the negative speaker unit 1221. Since the 2n−1-th acoustic signal and the 2n-th acoustic signal have an opposite phase relationship to each other, the sound can be heard only in the vicinity of the seat where the speaker system 120 is installed, as described in <Technical Background>. For example, in the case where N=2 is established, when the first acoustic signal and the third acoustic signal are respectively an acoustic signal of a right channel and an acoustic signal of a left channel of a certain sound source, a stereo sound can be heard only in the vicinity of the seat where the speaker system 120 is installed.

Note that the sound emitted in the n-th user direction from the positive speaker unit 1221 of the n-th speaker unit pair 122 and the sound emitted in an opposite direction to the n-th user direction from the positive speaker unit 1221 of the n-th speaker unit pair 122 have an opposite phase relationship to each other. Similarly, the sound emitted in the n-th user direction from the negative speaker unit 1221 of the n-th speaker unit pair 122 and the sound emitted in an opposite direction to the n-th user direction from the negative speaker unit 1221 of the n-th speaker unit pair 122 have an opposite phase relationship to each other.

According to the embodiment of the present invention, it is possible to reproduce the sound that can be heard only in the very limited narrow range in the vicinity of the speaker system. Note that the vicinity is a distance defined in consideration of experiment results based on environment in accordance with frequency and degree of sound erasure. For example, in the case where a state of the sound at a distance where a sound pressure at a position separated from the center of the speaker diaphragm by about the diameter of the speaker diaphragm is changed to a sound pressure equivalent to a background noise by gradually separating from the center of the speaker diaphragm is regarded as the erasure of the sound in <<3: Experiment Result>>, the “vicinity” is set to a distance separated from the center of the speaker diaphragm by about twice the diameter of the speaker diaphragm, for example. In addition, in another way, when an environment having a certain degree of background noise such as inside a vehicle is assumed, the range of vicinity is set so that a person sitting on the seat where the speaker system 120 is installed can hear and a person sitting on the adjacent seat cannot hear. For example, in the case where the sound radiated from the speaker unit is radiated to the periphery and becomes a sound pressure equivalent to the background noise is regarded as the erasure of the sound in <<3: Experiment Result>>, the “vicinity” can be regarded as a distance of about twice the shoulder width of the user from the center of the speaker diaphragm.

### Second Embodiment

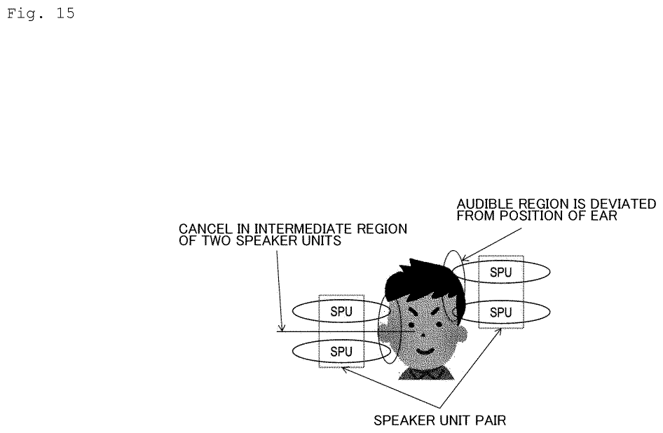

FIG. 15 is a diagram showing a situation of the sound emitted from the speaker unit pair. An SPU in the figure represents the speaker unit. In the case of the speaker unit pair installed near the right ear, sounds from the respective speaker units cancel each other in the intermediate region of the two speaker units, so that a region where the sounds emitted from the speaker unit pair cannot be heard is generated, and the user cannot hear the sounds. On the other hand, in the case of the speaker unit pair installed near the left ear, a region where the sound emitted from the speaker unit pair can be heard is deviated from the position of the ear, so that the user cannot hear the sounds. That is, (i) when both or either one of the right and left ears are located in the intermediate region, (ii) when both or either one of the right and left ears are deviated from the audible region, or (iii) when either one of the right and left ears is located in the intermediate region and the other is deviated from the audible region, a situation occurs in which a user cannot hear the sound or hardly hears the sound. In order to solve such a problem, the directivity of the sound emitted from the speaker unit pair is controlled. Here, a sound system for performing directivity control processing will be described.

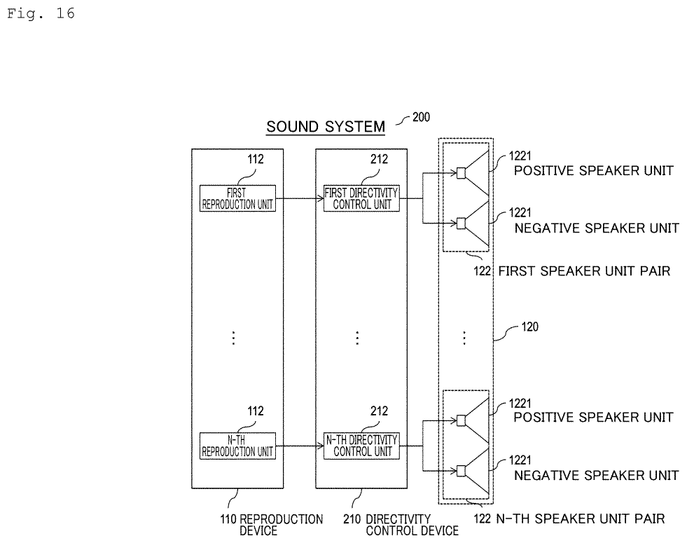

Hereinafter, a sound system 200 will be described with reference to FIG. 16. FIG. 16 is a block diagram showing a configuration of the sound system 200. As shown in FIG. 16, the sound system 200 includes the reproduction device 110, a directivity control device 210, and the speaker system 120. The directivity control device 210 includes N pieces of directivity control units 212 (that is, a first directivity control unit 212, . . . , an N-th directivity control unit 212). The sound system 200 is different from the sound system 100 in that it includes the directivity control device 210.

Hereinafter, in accordance with FIG. 16, operations of the directivity control device 210 and the speaker system 120 will be described.

The directivity control device 210 inputs the first acoustic signal, the second acoustic signal, . . . , and the 2N-th acoustic signal outputted by the reproduction device 110, and outputs a first processed acoustic signal which is a signal obtained by signal processing the first acoustic signal, a second processed acoustic signal which is a signal obtained by signal processing the second acoustic signal, . . . , and a 2N-th processed acoustic signal which is a signal obtained by signal processing the 2N-th acoustic signal. More specifically, a n-th directivity control unit 212 (n=1, . . . , N) inputs the 2n−1-th acoustic signal and the 2n-th acoustic signal, generates a 2n−1-th processed acoustic signal from the 2n−1-th acoustic signal and a 2n-th processed acoustic signal from the 2n-th acoustic signal by executing predetermined signal processing, and outputs the 2n−1-th processed acoustic signal and the 2n-th processed acoustic signal. Here, the predetermined signal processing is processing for controlling the directivity, and for example, a method of Reference Document 1, other directivity control techniques can be used. It is needless to say that the predetermined signal processing may be realized by the directivity control by other methods. In short, any technique may be used as long as the directivity control can be performed in accordance with the position of the user's ear and the position of the speaker unit pair.

(Reference Document 1) Futoshi Asano, “array signal processing of sound-localization, tracking and separation of sound source”, CORONA PUBLISHING CO., LTD, 2011, p. 69-91 The predetermined signal processing is, for example, filtering using an FIR (Finite Impulse Response) filter. The FIR filter used here is designed so that microphones are respectively installed in a region to be audible and a region not to be audible, that the value of the filter coefficient is made to approach 1 in the microphone installed in the region to be audible, and that the value of the filter coefficient is made to approach 0 in the microphone installed in the region not to be audible. This is described specifically hereinafter. The region to be audible and the region not to be audible need to be designed in accordance with the case. For example, a case to be installed in the seat (hereinafter referred to as a seat S) of the automobile is considered. A position where the ear is present when a user who uses the seat S moves the head or changes the direction of the face is included in the region to be audible, and a position where the ear is present when a user who uses a seat close to the seat S (for example, an adjacent seat or front and rear seats) moves the head or changes the direction of the face is included in the region not to be audible. Therefore, for example, in a microphone installed in the region including the seat close to the seat S but not including the seat S, the value of the filter coefficient is made to approach 0. Note that in consideration that the sound may not be heard even at the position where the ear is present when the head is moved or the direction of the face is changed because of the fact that the sounds cancel each other in the intermediate region between the two speaker units as described above, and the value of the filter coefficient in the microphone installed in the intermediate region is made to approach 1. In short, the microphone installed in the region where the user's ear is assumed to be present should be controlled so that the filter coefficient is made to approach 1, and the microphone installed in the region where the user's ear is assumed not to be present should be controlled so that the filter coefficient is made to approach 0. In other words, the filter may be configured so that the sound as large as possible may arrive in the region where the user's ear is assumed to be present, and the sound as small as possible may arrive in the region where the user's ear is assumed not to be present.

As a result, the n-th directivity control unit (n=1, . . . , N) executes the signal processing so that the sound emitted from the positive speaker unit of the n-th speaker unit pair and the sound emitted from the negative speaker unit of the n-th speaker unit pair can be heard in the region to be audible in the vicinity of the n-th speaker unit pair and cannot be heard in the region not to be audible. Note that the region to be the audible region includes a point located at an equal distance from the positive speaker unit of the n-th speaker unit pair and the negative speaker unit of the n-th speaker unit pair, in which the sound emitted from the positive speaker unit of the n-th speaker unit pair and the sound emitted from the negative speaker unit of the n-th speaker unit pair cancel each other.

The speaker system 120 inputs the first processed acoustic signal, the second processed acoustic signal, . . . , and the 2N-th processed acoustic signal outputted by the directivity control device 210, and emits the sound based on the first processed acoustic signal, and emits the sound based on the second processed acoustic signal, . . . and the sound based on the 2N-th processed acoustic signal. More specifically, the n-th speaker unit pair 122 (n=1, . . . . N) inputs the 2n−1-th processed acoustic signal and the 2n-th processed acoustic signal, and emits the sound based on the 2n−1-th processed acoustic signal from the positive speaker unit 1221, and the sound based on the 2n-th processed acoustic signal from the negative speaker unit 1221.

### Modification Example

Here, a sound system in which a higher region sound is hardly leaked by using a member having a sound absorption characteristic will be described.

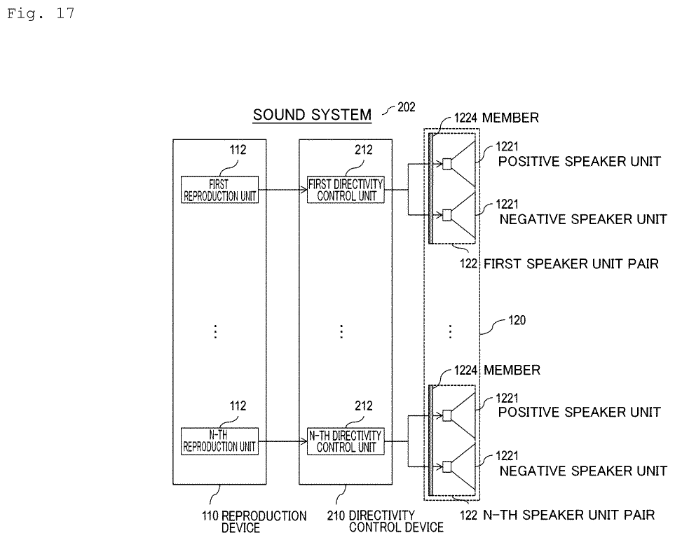

Hereinafter, a sound system 202 will be described with reference to FIG. 17. FIG. 17 is a block diagram showing a configuration of the sound system 202. As shown in FIG. 17, the sound system 202 includes the reproduction device 110, the directivity control device 210, and the speaker system 120, similarly to the sound system 200. However, the sound system 202 is different from the sound system 200 in that a member 1224 is attached to the speaker unit pair 122.

The structure of the n-th speaker unit pair 122 (n=1, . . . , N) will be described below in accordance with FIG. 17.

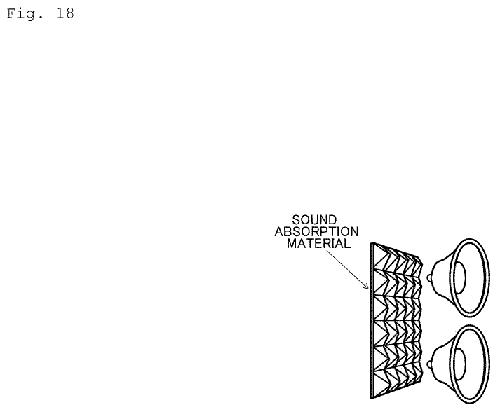

The n-th speaker unit pair 122 is provided with the member 1224 that absorbs sounds emitted in the opposite direction to the n-th user direction from the positive speaker unit 1221 and the negative speaker unit 1221 of the n-th speaker unit pair 122 (see FIG. 18). The member 1224 may be any member as long as it can prevent higher region sound from being radiated on the back. Note that instead of installing the member 1224 only on the back of the speaker unit pair 122, the member 1224 may be installed so as to surround other than the front of the speaker unit pair 122.

### (Example of Sound System Installed in Seat of Automobile)

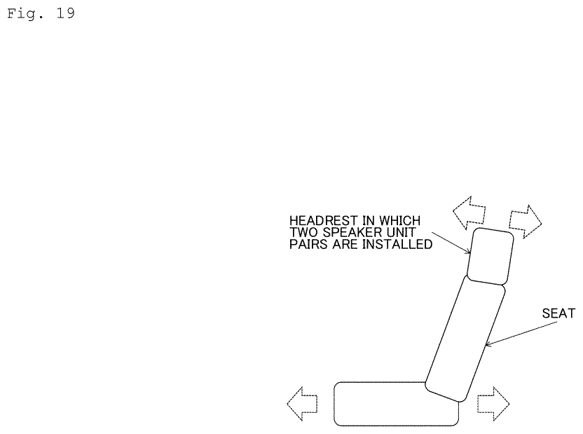

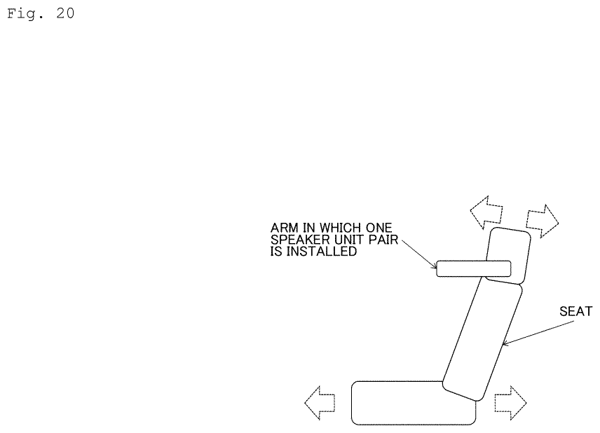

FIG. 19 and FIG. 20 are diagrams showing examples of sound systems installed in seats of automobiles, respectively. In the example shown in FIG. 19, a speaker unit pair is installed on a headrest of the seat of the automobile. Specifically, N=2 is established, and a first speaker unit pair and a second speaker unit pair are installed on the headrest of the seat of the automobile. On the other hand, in the example shown in FIG. 20, a speaker unit pair is installed on an arm that can be attached to the seat of the automobile. Specifically, N=2 is established, and the speaker unit pairs are respectively installed on two arms attached to the seat so as to sandwich the head of a user who uses the seat of the automobile. Note that the arm may be a movable type.

### Other Examples

Examples other than the seat of the automobile, specifically, a seat for an amusement machine such as a pachinko machine and a slot machine, will be described. Usually, a user uses a seat in front of the amusement machine to enjoy the amusement on the amusement machine. Therefore, the arm as described in the example of the automobile may be installed for the seat of the amusement machine, and the speaker unit pair may be present near the position where the ear of the user seated on the seat is present. Note that since the seat of the amusement machine has no backrest, the arm may be installed on the amusement machine instead of installing the arm on the seat. Alternatively, the arm may be a movable type, and the user may adjust the speaker unit pair so that the speaker unit pair is present near the ear.

### Third Embodiment

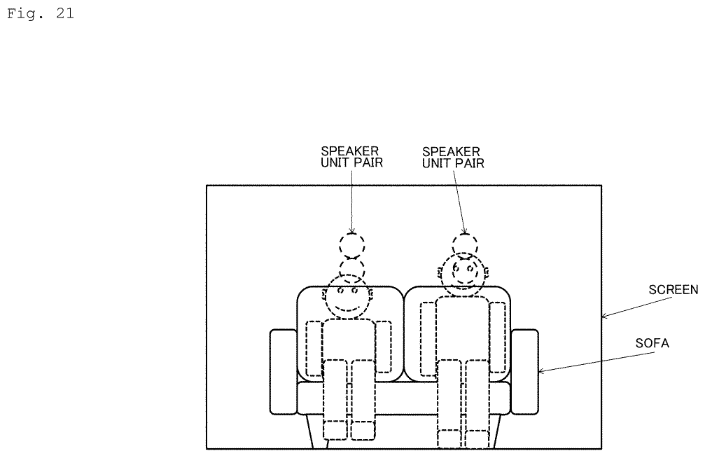

FIG. 21 is a diagram showing an example of a configuration of a sound system according to the present embodiment installed on a screen. The sound system shown in FIG. 21 is installed on the screen, and two speaker unit pairs are arranged side by side in a horizontal direction, and two speaker units included in each speaker unit pair are arranged side by side in a vertical direction. In this example, the screen is installed behind a sofa on which users sit.

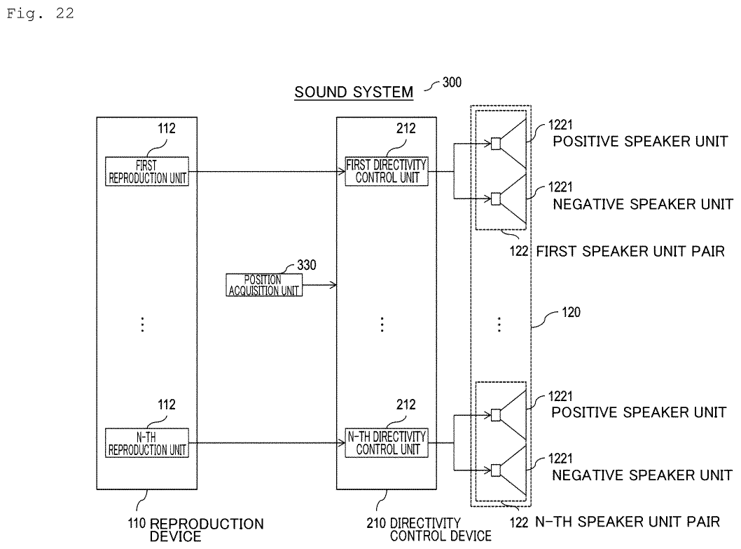

Hereinafter, a sound system 300 will be described with reference to FIG. 22. FIG. 22 is a block diagram showing a configuration of the sound system 300. As shown in FIG. 22, the sound system 300 includes the reproduction device 110, a position acquisition unit 330, the directivity control device 210, and the speaker system 120. The sound system 300 is different from the sound system 200 in that it includes the position acquisition unit 330.

Hereinafter, in accordance with FIG. 22, operations of the position acquisition unit 330 will be described.

The position acquisition unit 330 changes the directivity of directivity control processing performed in the directivity control device 210 so that the directivity of the sound emitted by the speaker unit pair is directed to the position where the user's auditory organ exists, in accordance with the position where the user's auditory organ exists and the position where the speaker unit pair exists. Note that in the present embodiment, speakers are aligned vertically in order to control the listening region in which the height of the user's auditory organs is emphasized. When the height of the user's auditory organs is almost the same as in the case where the same user exclusively uses, the speakers may be aligned horizontally to control the directivity in the lateral direction. It is preferable that the speaker closer to the ear position is a positive speaker unit and the speaker farther from the ear position is a negative speaker unit when the speakers are aligned vertically and horizontally. The switching of the roles of the positive and negative speakers is performed by a filter used in the directivity control device 210.

First, the position acquisition unit 330 acquires a position where the user's auditory organ exists. Note that the position may be acquired through any method. Hereinafter, an example in which the position acquisition unit 330 estimates the position and an example in which the user selects the position will be described.

### (Acquisition Method 1 (Position Estimation))

For example, the position acquisition unit 330 estimates the position of the user's head, and estimates the position where the auditory organ exists from the position of the head. Note that the position of the head may be estimated through any method.

For example, the user's head is photographed by using a camera or the like, a feature amount is extracted from the photographed image, and the position where the head or the auditory organ of the user exists is estimated from the extracted feature amount.

### (Acquisition Method 2 (User Selection))

For example, the position acquisition unit 330 has a selection unit such as a button that is not shown, and the user selects the position of the head or the auditory organ via the selection unit, a position where the user's auditory organ exists may be acquired from the selection result. It is also possible to have a communication function that is not shown and to select from a terminal owned by a user. The terminal may be configured integrally with the sound system, or may be a terminal owned by a user such as a smartphone or a tablet.

Next, the position acquisition unit 330 selects a filter in which the directivity of the sound emitted by the speaker unit pair is directed to the position where the user's auditory organ exists, and sets the selected filter as a filter to be used in the directivity control device 210. In short, the position acquisition unit 330 changes a filter used in the directivity control device 210 in accordance with a positional relationship between the positions where the speaker unit pair exists and where the user's auditory organ exists to change a region to be audible and a region not to be audible, and it is only necessary to design so that the position where the user's auditory organ exists (the position assumed to exist) becomes the region to be audible, and the position where the user's auditory organ does not exist (the position assumed not to exist) becomes the region not to be audible. Note that the positional relationship may be determined based on the estimated or selected positions of the head and the auditory organ and the reference location of the speaker unit pair (for example, the center position of the speaker unit pair, the center or lower end position of the speaker near the ground, etc.).

The filter may be obtained by calculation in advance by simulation or experiment, and stored in a storage unit that is not shown in association with the positional relationship between the position where the speaker unit pair and the position where the user's auditory organ exists. Instead of selecting the filter, the filter may be sequentially calculated so that the directivity of the sound emitted by the speaker unit pair is directed to the position where the user's auditory organ exists.

### (Control Example of Directivity)

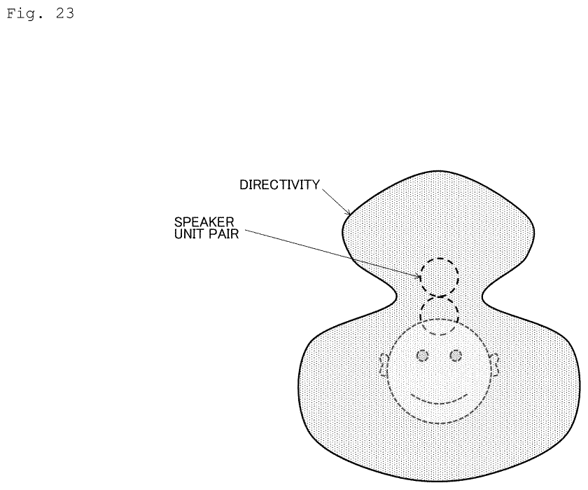

As shown in FIG. 23, when the position where the user's auditory organ exists is lower than the position where the speaker unit pair exists, control is performed so that the directivity of the sound emitted by the speaker unit pair is directed to a lower direction.

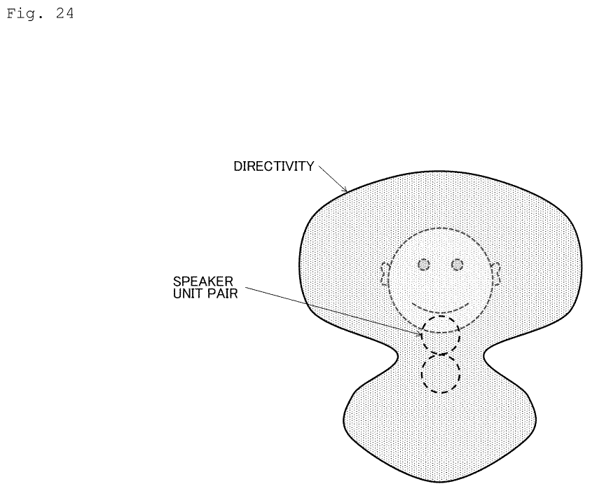

As shown in FIG. 24, when the position where the user's auditory organ exists is higher than the position where the speaker unit pair exists, control is performed so that the directivity of the sound emitted by the speaker unit pair is directed to a higher direction.

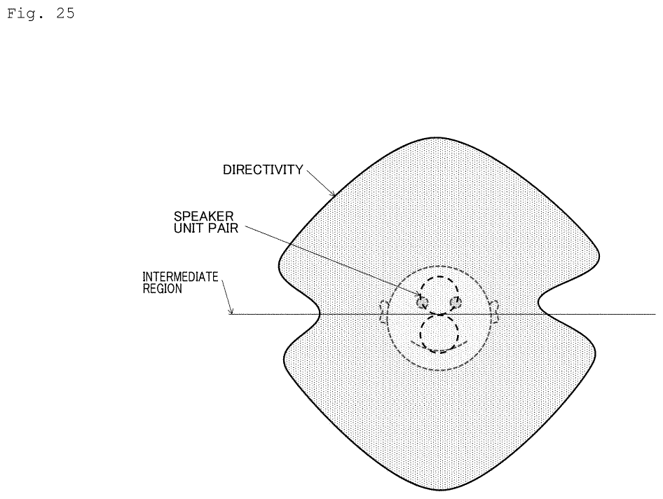

As shown in FIG. 25, when the position where the user's auditory organ exists is substantially the same height as the position where the speaker unit pair exists, the directivity of the sound emitted by the speaker unit pair is controlled so that the user can hear the sound at a point located at equal distance from the positive speaker and the negative speaker. Note that when the position where the user's auditory organ exists is substantially the same height as the position where the speaker unit pair exists, it means that the position where the user's auditory organ exists on a plane (in short, the intermediate region of the second embodiment) formed by points located at equal distances from the positive speaker and the negative speaker. A filter designed so that a region (a region where sound pressure becomes lower) where directivity formed between the positive speaker and the negative speaker is not directed becomes small is selected. Note that, in this case, there is a trade-off relationship in which the sound leakage to the surroundings becomes larger as the region (the region where the sound pressure becomes lower) where the directivity is not directed is made smaller.

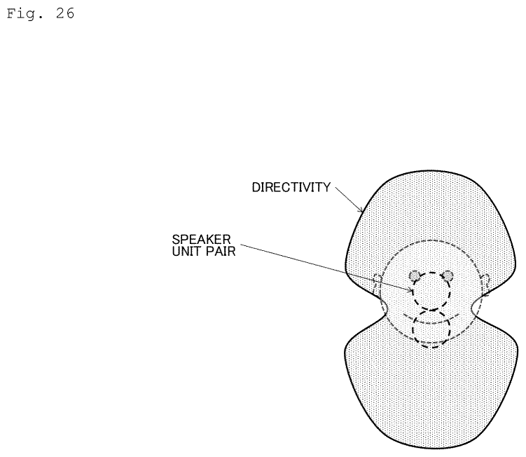

As shown in FIG. 26, when the position where the user's auditory organ exists is substantially the same height as the position where the positive speaker or the negative speaker exists, the directivity of the sound emitted by the speaker unit pair is controlled so that the region where the user can hear becomes small. This control can reduce the sound leakage to the surroundings.

For example, a filter for achieving directivity as shown in FIG. 23 to FIG. 26 is obtained by simulation or experiment in advance, and stored in a storage unit that is not shown in association with the position where the auditory organ exists, the position acquisition unit 330 acquires the position where the user's auditory organ exists, selects the corresponding filter from the storage unit that is not shown from the positional relationship between the speaker unit pair and the acquired position where the user's auditory organ exists, and sets the selected file in the directivity control device 210.

In the directivity control device 210, processing is performed by using the filter selected by the position acquisition unit 330. Since the processing itself performed in the directivity control device 210 is similar to that of the second embodiment, the description thereof will be omitted.

Note that, as described in the second embodiment, the positive speaker and the negative speaker emit sounds in a predetermined direction so as to have opposite phases to each other in the region not to be audible. In addition, as described in the first embodiment, the positive speaker unit and the negative speaker unit are obtained by removing the speaker box from the speaker, and are arranged so that the sound emitted from the positive speaker unit in a direction opposite to the n-th user direction and the sound emitted from the negative speaker unit in a direction opposite to the n-th user direction are transmitted in the n-th user direction by wraparound.

According to the embodiment of the present invention, it is possible to reproduce a sound that can be heard only in a very limited narrow range in the vicinity of the speaker system, and it is possible to appropriately control the directivity in accordance with the position where the user's auditory organ exists.

Note that the present embodiment and the modification example of the second embodiment may be combined.

Further, in the present embodiment, an example where N=2 is established has been described, but N may be either 1 or an integer of 3 or more, even when N is an integer of 2 or more, localized reproduction can be performed, and directivity can be appropriately controlled in accordance with the position where the user's auditory organ exists.

In this embodiment, the sound system is installed on the screen, but it may be installed on a wall or a digital signage. In short, in an environment where a plurality of users having different heights uses, the directivity control of the speaker unit pair arranged on one plane should be performed in order to form the region where other users including other users located at an adjacent position cannot hear and only target user can hear.

### Modification Example 1

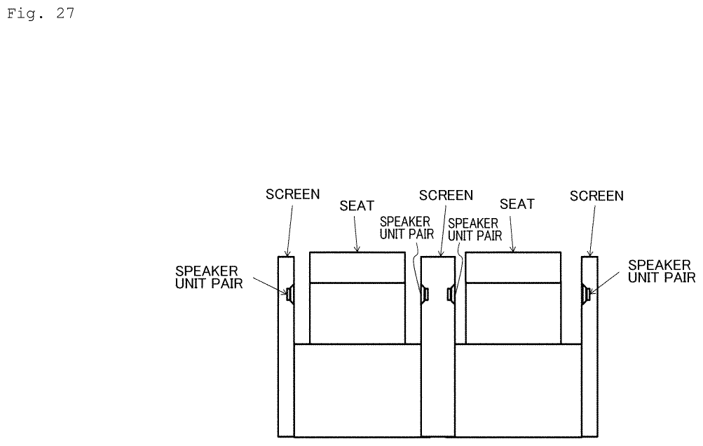

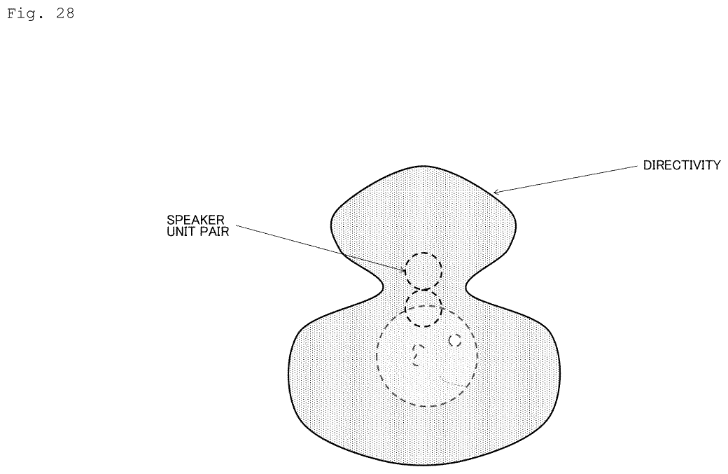

In the present embodiment, a screen is installed behind a sofa on which a user sits, but a sound system may be incorporated into the screen (for example, the screen installed in a library, a co-working space, or the like as shown in FIG. 27) installed between the user and the user. As shown in FIG. 28, the directivity control similar to that of the third embodiment can be performed for each channel.

### Fourth Embodiment

FIG. 21 is a diagram showing an example of a sound system installed on a screen. The sound system shown in FIG. 21 is installed on the screen, and two speaker unit pairs are arranged side by side in a horizontal direction, and two speaker units included in each speaker unit pair are arranged side by side in a vertical direction. In this example, the screen is installed behind a sofa on which a user sits. Prior to describing details in the present embodiment, an overview will be described. Generally, a speaker array is composed of a number of speakers, and an acoustic signal subjected to array signal processing is emitted from each speaker in order to emit the acoustic signal of desired characteristics. It may be said that the speakers belonging to the speaker array are selected to perform processing. In the present embodiment, the speaker array located at a position most easily heard by a user is selected from among a plurality of speaker arrays. This is because, as described in the foregoing embodiments, the sound system is configured to be viewable only in the immediate vicinity of the user, and therefore, depending on the height and the sitting position of the user to be heard, there may be a case where the user cannot be heard without moving the speaker position itself. In the present embodiment, in order to solve such a problem, a plurality of speaker arrays is prepared, and the speaker array itself is selected depending on the position where the user views. Note that, in order to facilitate the description, the speaker unit pair is described here as the speaker array.

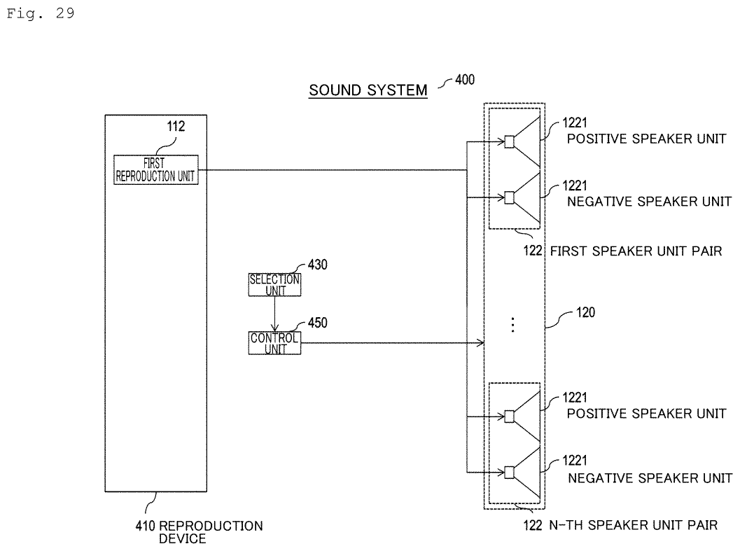

Hereinafter, a sound system 400 will be described with reference to FIG. 29. FIG. 29 is a block diagram showing a configuration of the sound system 300. As shown in FIG. 29, the sound system 400 includes a reproduction device 410, a selection unit 430, a control unit 450, and the speaker system 120.

Hereinafter, in accordance with FIG. 29, operations of the sound system 400 will be described.

The sound system 400 inputs a first acoustic signal which is an acoustic signal obtained based on the reproduction objects.

The reproduction device 410 inputs the first acoustic signal which is an acoustic signal obtained based on the reproduction objects, and outputs the first acoustic signal and the second acoustic signal. The reproduction device 410 includes a first reproduction unit 112, and the first reproduction unit 112 inputs the first acoustic signal, generates and outputs the second acoustic signal which is an acoustic signal having an opposite phase to that of the first acoustic signal from the first acoustic signal. The first acoustic signal and the second acoustic signal are inputted to a positive speaker unit 1221 and a negative speaker unit 1221 of the n-th (n=1, 2, . . . , N) speaker unit pair 122, respectively. In the present embodiment, N is any integer of 2 or more.

The selection unit 430 selects any one speaker unit pair in accordance with the position of the user's auditory organ and the position of the speaker unit pair, and outputs the selection result to the control unit 450.

First, the selection unit 430 acquires the position where the user's auditory organ exists. Note that the position may be acquired through any method. For example, the position where the user's auditory organ exists is acquired by estimating or selecting by the method similar to that of the position acquisition unit 330 of the third embodiment.

Next, the selection unit 430 selects a speaker unit pair existing at the nearest position to the position where the user's auditory organ exists, and outputs the selection result to the control unit 450. For example, the selection unit 430 may measure and obtain the position of each speaker unit pair in advance, store it in a storage unit that in not shown, and select the speaker unit pair corresponding to the position which has the smallest distance from the position where the acquired user's auditory organ exists.

The control unit 450 controls to emit the first acoustic signal only from the positive speaker of the selected speaker unit pair and to emit the second acoustic signal only from the negative speaker of the selected speaker unit pair, and the speaker system 120 inputs the first acoustic signal and the second acoustic signal to emit a sound based on the first acoustic signal from the positive speaker 1221 of the selected speaker unit pair, and emit a sound based on the second acoustic signal from the negative speaker 1221 of the selected speaker unit pair, in accordance with the control of the control unit 450. Since the first acoustic signal and the second acoustic signal are in opposite phase relation to each other, the sound can be heard only in the vicinity of the selected speaker unit pair as described in “Technical Background”.

In the present embodiment, the sound system is installed on the screen, but it may be installed on a wall or a digital signage. In short, in an environment in which a plurality of users having different positions uses, a speaker unit pair should be selected by arranging a plurality of speaker unit pairs on one plane in order to form the region where other users including other users located at an adjacent position cannot hear and only target user can hear.

Although one speaker unit pair is selected in the selection unit 430 according to the present embodiment, when there are two or more users, it is also possible to select speaker unit pairs for the detected number of persons, and to control the control unit 450 to emit sounds from all the selected speaker unit pairs.

Note that the present embodiment and the third embodiment may be combined. In this case, the selection unit 430 according to the present embodiment selects one speaker unit pair from among N pieces of speaker unit pairs, gives the directivity from the position of the speaker unit pair selected by the directivity control device 210 of the third embodiment to the position of the user's auditory organ, and emits the sound from the speaker unit pair selected by the control of the control unit 450.

### Modification Example

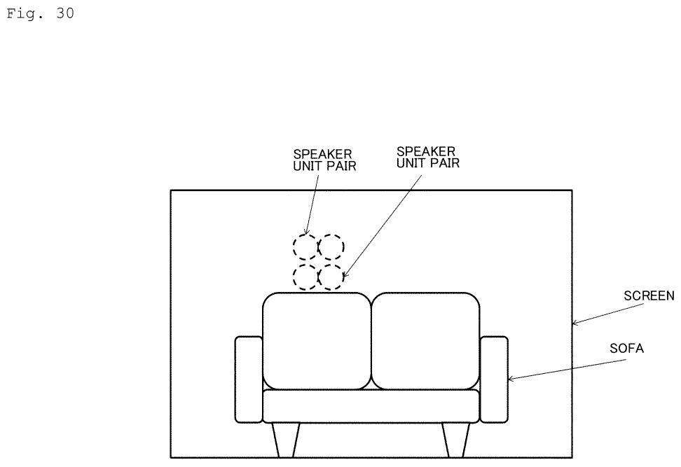

The sound system shown in FIG. 30 is installed on a screen, and two speaker unit pairs are arranged side by side in a vertical direction, and two speaker units included in each speaker unit pair are arranged side by side in a horizontal direction. Other configurations are similar to that of the fourth embodiment.

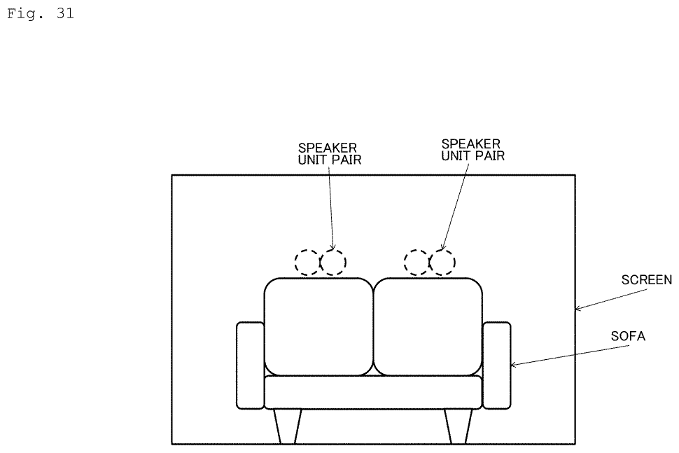

In addition, the sound system shown in FIG. 31 is installed on the screen, and two speaker unit pairs are arranged side by side in a horizontal direction, and two speaker units included in each speaker unit pair are arranged side by side in a horizontal direction. Other configurations are similar to that of the fourth embodiment.

### Fifth Embodiment

In the sound system of the second embodiment, only one-channel (monaural) acoustic signal can be reproduced by one speaker unit pair. If a two-channel (stereo) acoustic signal is to be reproduced, at least two speaker unit pairs are required.

In the present embodiment, a sound system capable of reproducing the two-channel (stereo) acoustic signal by one speaker unit pair will be described. Prior to the detail description, an overview according to the present embodiment will be described. As described above, a configuration in which a positive speaker unit (hereinafter also referred to as a first speaker) and a negative speaker unit (hereinafter also referred to as a second speaker) are in opposite phases to each other and any speaker does not have a speaker box is adopted, thereby realizing a sound system in which a sound can be heard only in the vicinity. In the present embodiment, the first speaker and the second speaker have two roles, respectively. In this case, for simplification of the description, a speaker that emits an acoustic signal for listening is called a main speaker, and the other speaker is called a cancel speaker. The role of the Lch main speaker and the role of the Rch cancel speaker are given to the first speaker, and the role of the Lch cancel speaker and the role of the Rch main speaker are given to the second speaker. By giving the directivity to signals emitted from the first speaker and the second speaker so as to serve as such a role, a stereo acoustic signal which can be heard only in the vicinity can be reproduced by one speaker unit pair.

In the present embodiment, the acoustic signal obtained based on the reproduction objects is two-channel (stereo) acoustic signal.

FIG. 31 is a diagram showing an example of the sound system according to the present embodiment installed on the screen. The sound system shown in FIG. 31 is installed on the screen, and two speaker unit pairs are arranged side by side in a horizontal direction, and two speaker units included in each speaker unit pair are arranged side by side in a horizontal direction. Note that although the screen will be described here as an example, the present invention may be applied to a seat of an automobile, a seat of an electric train, or an office chair, or to a speaker unit pair installed in a separator or a digital signage. In short, the invention described in the present embodiment may be applied to any sound system which reproduces a stereo acoustic signal that can be heard only in the vicinity with the smaller number of speakers than that in the first embodiment.

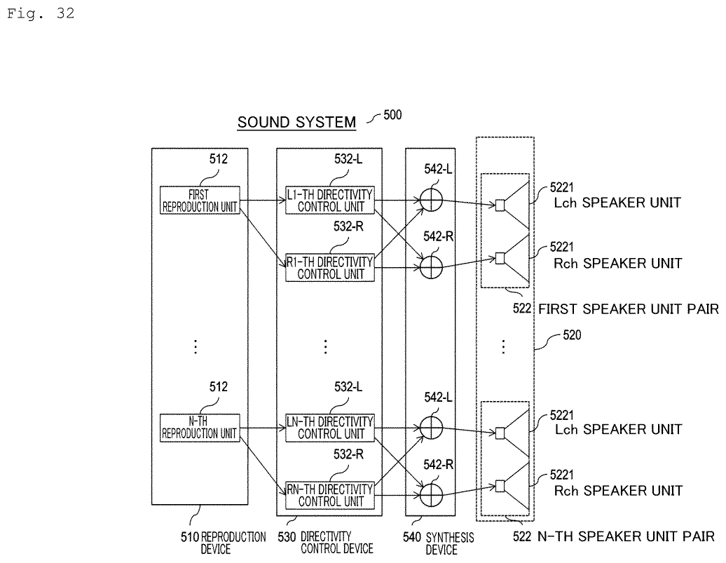

Hereinafter, a sound system 500 will be described with reference to FIG. 32. FIG. 32 is a block diagram showing a configuration of the sound system 500. As shown in FIG. 32, the sound system 500 includes a reproduction device 510, a directivity control device 530, a synthesis device 540, and a speaker system 520.

The reproduction device 510 includes N (where N is an integer of 1 or more) pieces of reproduction units 512 (that is, a first reproduction unit 512, . . . , and an N-th reproduction unit 512).

The directivity control device 530 includes 2N pieces of directivity control units 532 (that is, an L1-th directivity control unit 532-L, . . . , an LN-th directivity control unit 532-L, an R1-th directivity control unit 532-R, . . . , an RN-th directivity control unit 532-R).

The synthesis device 540 includes 2N pieces of synthesis units 542 (that is, an L1-th synthesis unit 542-L, . . . , an LN-th synthesis unit 542-L, an R1-th synthesis unit 542-R, . . . , an RN-th synthesis unit 542-R).

The speaker system 520 includes N pieces of speaker unit pairs 522 (that is, a first speaker unit pair 522, . . . , an N-th speaker unit pair 522). The speaker unit pair 522 includes two speaker units (that is, a Lch speaker unit 5221 and a Rch speaker unit 5221). The speaker system 520 is installed on the screen near the head of the user using the sofa.

Further, the Lch speaker unit 5221 and the Rch speaker unit 5221 of the n-th speaker unit pair 522 (n=1, . . . , N) are arranged in a positional relationship in which the sound emitted from the Lch speaker unit 5221 and the sound emitted from the Rch speaker unit 5221 are erased from each other so that a user using another seat cannot hear them.

Hereinafter, in accordance with FIG. 32, operations of the sound system 500 will be described.

The reproduction device 510 inputs an L1-th acoustic signal and an R1-th acoustic signal, an L3-th acoustic signal and an R3-th acoustic signal, . . . , an L (2N−1)-th acoustic signal and an R (2N−1)-th acoustic signal that are two-channel acoustic signals obtained based on the reproduction objects, and outputs the L1-th acoustic signal and the R1-th acoustic signal, the L2-th acoustic signal and the R2-th acoustic signal, . . . , the L (2N)-th acoustic signal and the R (2N)-th acoustic signal. More specifically, the n-th reproduction unit 512 (n=1, . . . , N) inputs the L (2n−1)-th acoustic signal and the R (2n−1)-th acoustic signal, generates the L (2n)-th acoustic signal which is an acoustic signal having an opposite phase to that of the L (2n−1)-th acoustic signal from the L (2n−1)-th acoustic signal, generates the R (2n)-th acoustic signal which is an acoustic signal having an opposite phase to that of the R (2n−1)-th acoustic signal from the R (2n−1)-th acoustic signal, and outputs the L (2n−1)-th acoustic signal and the L (2n)-th acoustic signal and the R (2n−1)-th acoustic signal and the R (2n)-th acoustic signal. The L (2n−1)-th acoustic signal and the L (2n)-th acoustic signal are inputted to the Ln-th directivity control unit 532-L, and the R (2n−1)-th acoustic signal and the R (2n)-th acoustic signal are inputted to the Rn-th directivity control unit 532-R.

The directivity control device 530 inputs the L1-th acoustic signal and the R1-th acoustic signal, the L2-th acoustic signal and the R2-th acoustic signal, . . . , the L (2N)-th acoustic signal and the R (2N)-th acoustic signal outputted by the reproduction device 510, and outputs an L1-th processed acoustic signal which is a signal obtained by signal-processing the L1-th acoustic signal, an L2-th processed acoustic signal which is a signal obtained by signal-processing the L2-th acoustic signal, . . . , an L (2N)-th processed acoustic signal which is a signal obtained by signal-processing the L (2N)-th acoustic signal, an R1-th processed acoustic signal which is a signal obtained by signal processing the R1-th acoustic signal, an R2-th processed acoustic signal which is a signal obtained by signal processing the R2-th acoustic signal, . . . , an R (2N)-th processed acoustic signal which is a signal obtained by signal processing the R (2N)-th acoustic signal.

More specifically, the Ln-th directivity control unit 532-L (n=1, . . . , N) inputs the L (2n−1)-th acoustic signal and the L (2n)-th acoustic signal, generates the L (2n−1)-th processed acoustic signal from the L (2n−1)-th acoustic signal and the L (2n)-th processed acoustic signal from the L (2n)-th acoustic signal by executing predetermined signal processing, and outputs the L (2n−1)-th processed acoustic signal and the L (2n)-th processed acoustic signal.

Similarly, the Rn-th directivity control unit 532-R (n=1, . . . , N) inputs the R (2n−1)-th acoustic signal and the R (2n)-th acoustic signal, generates the R (2n−1)-th processed acoustic signal from the R (2n−1)-th acoustic signal and the R (2n)-th processed acoustic signal from the R (2n)-th acoustic signal by executing predetermined signal processing, and outputs the R (2n−1)-th processed acoustic signal and the R (2n)-th processed acoustic signal.

Here, the predetermined signal processing is processing for controlling the directivity described in the second embodiment, and includes, for example, a filter processing having a coefficient as described below.

This is described specifically hereinafter. The region to be audible and the region not to be audible need to be designed in accordance with the case. For example, a case to be installed in the seat (hereinafter referred to as a seat S) of the automobile is considered. In the Ln-th directivity control unit 532-L, the position where the left ear of the user using the seat S is present is included in the region to be audible, and other positions are included in the region not to be audible. In addition, in the Rn-th directivity control unit 532-R, the position where the right ear of the user using the seat S is present is included in the region to be audible, and other positions are included in the region not to be audible. Therefore, for example, in the Ln-th directivity control unit 532-L, a value of a filter coefficient is made to approach 0 in a microphone installed in a region including a left seat close to the seat S but not including a position where a left ear of a user using the seat S is present. In the Rn-th directivity control unit 532-R, a value of a filter coefficient is made to approach 0 in a microphone installed in a region including a right seat close to the seat S but not including a position where a right ear of a user using the seat S is present. In short, the microphone installed in the region where the user's ear is assumed to be present should be controlled so that the filter coefficient is made to approach 1, and the microphone installed in the region where the user's ear is assumed not to be present should be controlled so that the filter coefficient is made to approach 0. In other words, the filter may be configured so that the sound as large as possible may arrive in the region where the user's ear is assumed to be present, and the sound as small as possible may arrive in the region where the user's ear is assumed not to be present.

As a result, the Ln-th directivity control unit (n=1, . . . , N) performs the signal processing so that the sound emitted from the Lch speaker unit of the n-th speaker unit pair and the sound emitted from the Rch speaker unit of the n-th speaker unit pair can be heard in the region to be audible (for example, a position where the user's left ear is present) in the vicinity of the n-th speaker unit pair and cannot be heard in the region not to be audible.

Similarly, the Rn-th directivity control unit (n=1, . . . , N) performs the signal processing so that the sound emitted from the Rch speaker unit of the n-th speaker unit pair and the sound emitted from the Lch speaker unit of the n-th speaker unit pair can be heard in the region to be audible (for example, a position where the user's right ear is present) in the vicinity of the n-th speaker unit pair and cannot be heard in the region not to be audible.

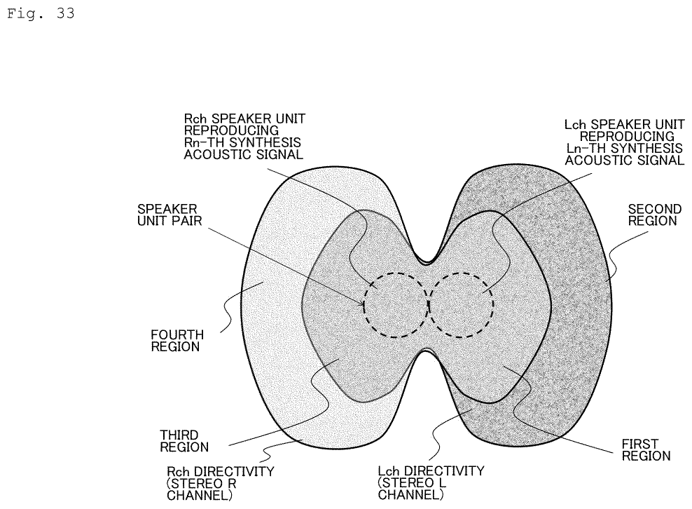

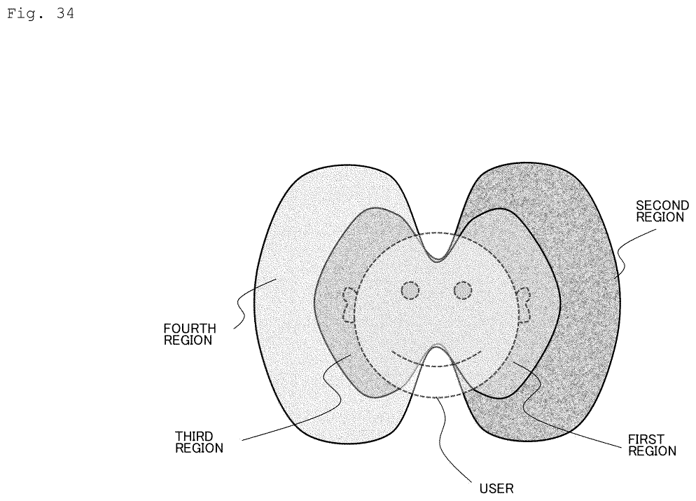

FIG. 33 and FIG. 34 are diagrams for explaining the region to be audible and the region not to be audible. The Rch speaker unit and the Lch speaker unit are aligned in a horizontal direction and installed on the screen. Here, it is assumed that the user's head is located approximately at the center of the speaker unit pair. The stereo L channel is reproduced by using the directivity for the L channel and the stereo R channel is reproduced by using the directivity for the R channel created in advance by the fixed filter, so that stereo reproduction can be performed by the speaker unit pair composed of two speaker units.

Note that the L (2n−1)-th processed acoustic signal is an acoustic signal to be made audible in the region (hereinafter, referred to as the first region) in a left direction of the directivity for the R channel, with respect to the direction where the user is facing viewed from the center of the speaker unit pair. The R (2n)-th processed acoustic signal is an acoustic signal to be made inaudible in the region (hereinafter, referred to as the fourth region) in a right direction of the directivity for the R channel, with respect to the direction where the user is facing viewed from the center of the speaker unit pair.

Similarly, note that the R (2n−1)-th processed acoustic signal is an acoustic signal to be made audible in the region (hereinafter, referred to as the third region) in a right direction of the directivity for the L channel, with respect to the direction where the user is facing viewed from the center of the speaker unit pair. The L (2n)-th processed acoustic signal is an acoustic signal to be made inaudible in the region (hereinafter referred to as the second region) in a left direction of the directivity for the L channel, with respect to the direction where the user is facing viewed from the center of the speaker unit pair.

The synthesis device 540 inputs the L1-th processed acoustic signal, the L2-th processed acoustic signal, . . . , the L (2N)-th processed acoustic signal, and the R1-th processed acoustic signal, the R2-th processed acoustic signal, R (2N)-th processed acoustic signal, synthesizes these signals, and obtains and outputs an L1-th synthesis acoustic signal, an L2-th synthesis acoustic signal, . . . an LN-th synthesis acoustic signal, an R1-th synthesis acoustic signal, an R2-th synthesis acoustic signal, . . . , an RN-th synthesis acoustic signal.

More specifically, the Ln-th synthesis unit 542-L (n=1, . . . , N) inputs the L (2n−1)-th processed acoustic signal and the R (2n)-th processed acoustic signal, synthesizes these signals, and obtains the Ln-th synthesis acoustic signal.

Similarly, the Rn-th synthesis unit 542-R (n=1, . . . , N) inputs the R (2n−1)-th processed acoustic signal and the L (2n)-th processed acoustic signal, synthesizes these signals, and obtains the Rn-th synthesis acoustic signal.

The speaker system 520 inputs the L1-th synthesis acoustic signal, the L2-th synthesis acoustic signal, . . . , the LN-th synthesis acoustic signal and the R1-th synthesis acoustic signal, the R2-th synthesis acoustic signal, the RN-th synthesis acoustic signal outputted by the synthesis device 540, and emits a sound based on the L1-th synthesis acoustic signal, a sound based on the L2-th synthesis acoustic signal, . . . , a sound based the LN-th synthesis acoustic signal and a sound based on the R1-th synthesis acoustic signal, a sound based on the R2-th synthesis acoustic signal, . . . , a sound based on the RN-th synthesis acoustic signal. More specifically, the n-th speaker unit pair 522 (n=1, . . . , N) inputs the Ln-th synthesis acoustic signal and the Rn-th synthesis acoustic signal, emits the sound based on the Ln-th synthesis acoustic signal from the Lch speaker unit 5221, and the sound based on the Rn-th synthesis acoustic signal from the Rch speaker unit 5221. An element based on the L (2n−1)-th processed acoustic signal of the Ln-th synthesis acoustic signal and an element based on the L (2n)-th processed acoustic signal of the Rn-th synthesis acoustic signal are in an opposite phase relationship, and an element based on the R (2n−1)-th processed acoustic signal of the Rn-th synthesis acoustic signal and an element based on the R (2n)-th processed acoustic signal of the Ln-th synthesis acoustic signal are in an opposite phase relationship, so that the sound is heard only in the vicinity of a seat where the speaker system 520 is installed, as described in <Technical Background>. For example, in the case where N=1 is established, when the L1-th acoustic signal and the R1-th acoustic signal which are acoustic signals of two channels obtained based on the reproduction objects are defined as an acoustic signal of a left channel and an acoustic signal of a right channel of a certain sound source, the stereo sound can be heard only in the vicinity of a position where the speaker system 520 is installed.

### Sixth Embodiment

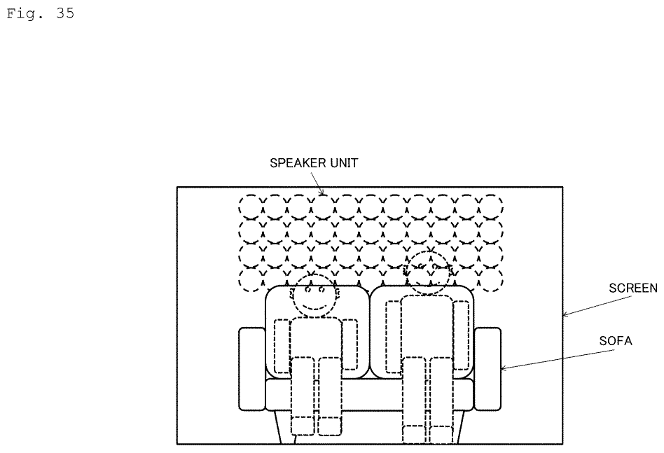

FIG. 35 is a diagram showing an example of a sound system installed on a screen according to the present embodiment. The sound system shown in FIG. 35 is installed on the screen, and M pieces of speaker units are arranged side by side located at equal distances in a horizontal direction and a vertical direction. The distance between two speaker units adjacent to each other in the horizontal direction and the vertical direction is set to a distance capable of realizing localized emission when the first acoustic signal and the second acoustic signal are emitted in the two adjacent speaker units. In this example, the screen is installed behind a sofa on which a user sits. M is any integer of 3 or more.

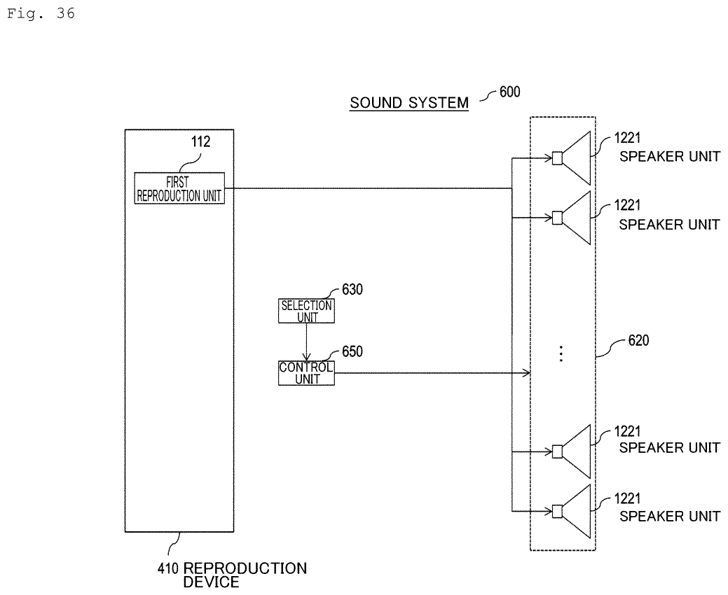

Hereinafter, a sound system 600 will be described with reference to FIG. 36. FIG. 36 is a block diagram showing a configuration of the sound system 600. As shown in FIG. 36, the sound system 600 includes the reproduction device 410, a selection unit 630, a control unit 650, and a speaker system 620.

Hereinafter, in accordance with FIG. 36, operations of the sound system 600 will be described.

The sound system 400 inputs a first acoustic signal which is an acoustic signal obtained based on the reproduction objects.

The reproduction device 410 inputs the first acoustic signal which is an acoustic signal obtained based on the reproduction objects, and outputs the first acoustic signal and the second acoustic signal. The reproduction device 410 includes a first reproduction unit 112, and the first reproduction unit 112 inputs the first acoustic signal, and generates and outputs the second acoustic signal which is an acoustic signal having an opposite phase to that of the first acoustic signal from the first acoustic signal. The first acoustic signal and the second acoustic signal are inputted to an m-th (n=1, 2, . . . , M) speaker unit.

The selection unit 630 selects two speaker units adjacent to each other in accordance with the position of the user's auditory organ and the position of the speaker unit pair, and outputs the selection result to the control unit 650.

First, the selection unit 630 acquires the position where the user's auditory organ exists. Note that the position may be acquired through any method. For example, the position where the user's auditory organ exists is estimated or selected by the same method as that of the selection unit 630 of the fourth embodiment.

Next, the selection unit 630 selects two adjacent speaker units existing at the nearest position to the position where the user's auditory organ exists, and outputs the selection result to the control unit 650. In other words, two speaker units are selected from a group of speaker units prepared in advance, and a speaker unit pair is temporarily constituted. For example, the selection unit 630 measures and obtains the position of each speaker unit in advance, stores the positions in a storage unit that is not shown, and selects two adjacent speaker units corresponding to the position which has the smallest distance from the position where the acquired user's auditory organ exists.

The control unit 650 controls so as to emit the first acoustic signal only from one speaker of the selected speaker unit and to emit the second acoustic signal only from the other speaker of the selected speaker unit, and the speaker system 620 inputs the first acoustic signal and the second acoustic signal, and emits a sound based on the first acoustic signal from the selected one speaker unit 1221 and emits a sound based on the second acoustic signal from the selected other speaker unit 1221 in accordance with the control of the control unit 650. Since the first acoustic signal and the second acoustic signal are in opposite phase relation to each other, the sound can be heard only in the vicinity of the selected speaker unit pair as described in <Technical Background>.

Although the selection unit 430 according to the present embodiment selects two speaker units, if the user is two or more, it is also possible to select speaker units for the number obtained by multiplying the detected number of users by two pieces, and the control unit 650 may be configured to control to emit sounds from all of the selected speaker units. Note that the present embodiment, the third embodiment, and the fifth embodiment may be combined.

### Seventh Embodiment

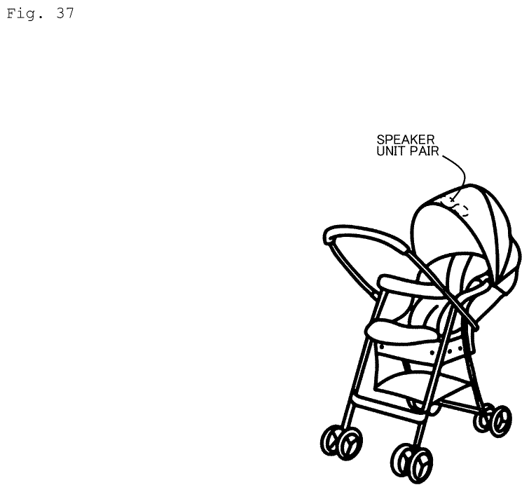

FIG. 37 is a diagram showing an example of a sound system installed in a vehicle according to the present embodiment. Note that a vehicle here is one in which a human rides and moves its position by turning wheels driven by human power or electric power, such as a stroller, pram, or wheelchair.

In the sound system shown in FIG. 37, a speaker unit pair is arranged side by side inside a hood of the stroller. Note that the seat side on which the baby rides is set to the inside, and the opposite direction is set to the outside.

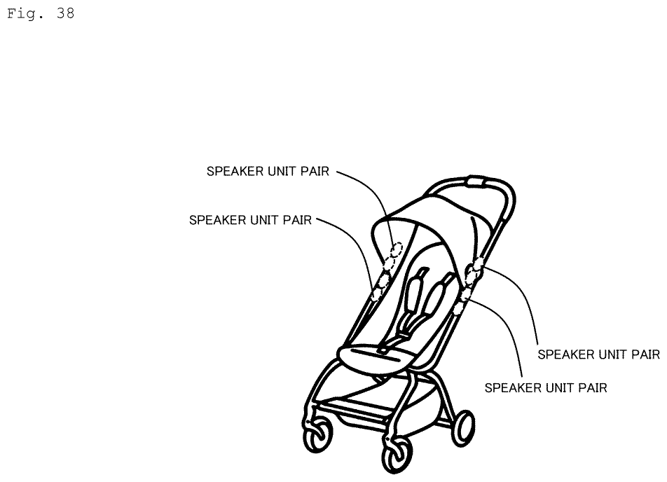

As shown in FIG. 38, the speaker unit pair may be installed side by side on the structure of the side of the stroller, or may be installed side by side in the vicinity of a connection point between the structure of the side of the stroller and the hood. In this case, the speaker unit pair may be arranged either on the outside or on the inside of the stroller, or either on the right or left. This arrangement has the advantage that the change in the audible region is small when the hood is opened or closed, so that listening can be continued without a mechanism such as switching of a filter described later.

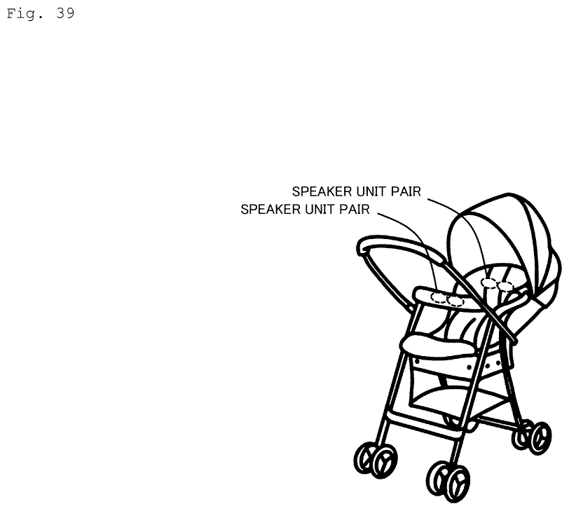

In addition, as shown in FIG. 39, the speaker unit pair may be installed side by side in the horizontal direction on the backrest portion. This arrangement has the advantage of forming a wide lateral audible region, and making it difficult for the baby not to hear even if he/she moves his/her face.

Further, as shown in FIG. 39, the speaker unit pair may be installed side by side inside the front bar. This arrangement has the advantage that if a configuration with a wider audible region is taken (by adding a member that increases the distance to the diffraction), the baby can continue to view even if he/she moves his/her face or body.

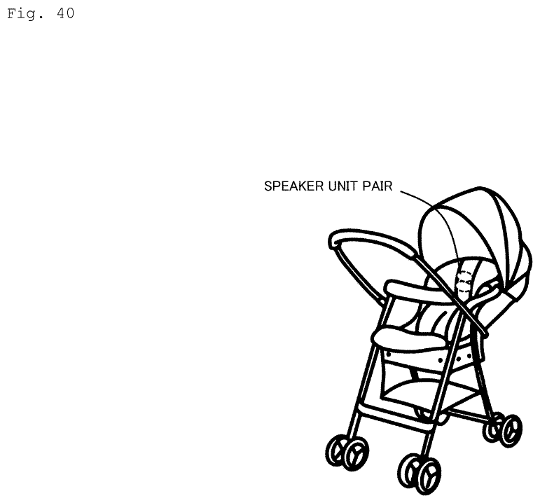

As shown in FIG. 40, the speaker unit pair may be arranged side by side in the horizontal direction on the backrest portion. This arrangement has the advantage of forming a vertically wide audible region, and making it difficult not to hear even if a baby's face slides down.

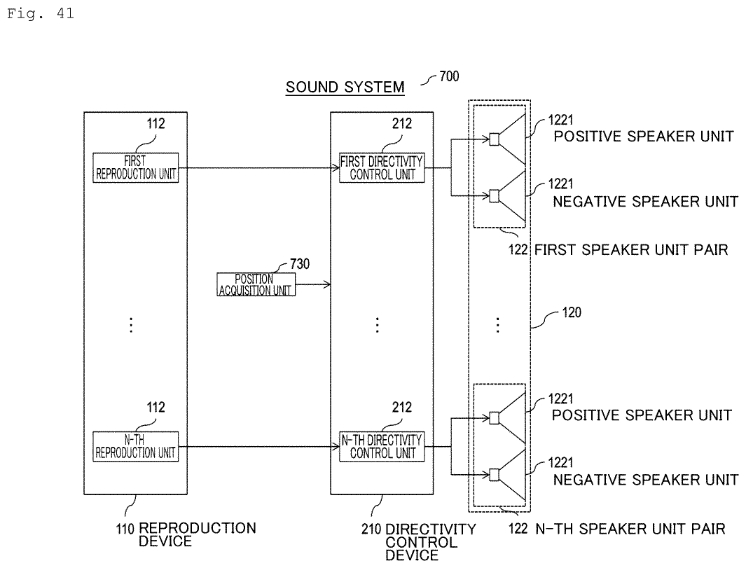

Hereinafter, a sound system 700 will be described with reference to FIG. 41. FIG. 41 is a block diagram showing a configuration of the sound system 700. As shown in FIG. 41, the sound system 700 includes the reproduction device 110, a position acquisition unit 730, the directivity control device 210, and the speaker system 120. The sound system 700 is different from the sound system 300 in that it includes the position acquisition unit 730.

The position acquisition unit 730 changes the directivity of directivity control processing performed in the directivity control device 210 so that the directivity of the sound emitted by the speaker unit pair is directed to the position where the user's auditory organ exists, in accordance with the position where the user's auditory organ exists and the position where the speaker unit pair exists.

Hereinafter, in accordance with FIG. 41, operations of the position acquisition unit 730 will be described.

The position acquisition unit 730 changes the directivity of directivity control processing performed in the directivity control device 210 so that the directivity of the sound emitted by the speaker unit pair is directed to the position where the user's auditory organ exists, in accordance with the position where the user's auditory organ exists and the position where the speaker unit pair exists.

First, the position acquisition unit 730 acquires the position where the user's auditory organ exists or the position where the speaker unit pair exists. Note that the position may be acquired through any method. Hereinafter, an example in which the position acquisition unit 730 estimates the position and an example in which the user selects the position will be described.

### (Acquisition Method 1 (Position Estimation))

For example, a pressure sensor is installed in the backrest portion, and it is estimated that the head of the user (baby) exists at a position where strong pressure is applied.

For example, the position acquisition unit 730 estimates the position of the user's head, and estimates the position where the auditory organ exists from the position of the head. Note that the position of the head may be estimated through any method.

For example, the user's head is photographed by using a camera or the like, a feature amount is extracted from the photographed image, and the position where the head or the auditory organ of the user exists is estimated from the extracted feature amount.

In addition, for example, when the speaker unit pair is installed in the hood as shown in FIG. 37, the position of the speaker unit pair installed in the hood is detected from a physical structure such as a state of a gear operating in conjunction with opening and closing of the hood.

### (Acquisition Method 2 (User Selection))

For example, the position acquisition unit 730 has a selection unit such as a button that is not shown, and a user (guardian or the like pushing a stroller) may select a position of a head or an auditory organ of the user (baby) via the selection unit, and acquire the position where the user's (baby's) auditory organ exists from the selection result.

Next, the position acquisition unit 730 selects a filter in which the directivity of the sound emitted by the speaker unit pair is directed to the position where the user's auditory organ exists, and sets the selected filter as a filter to be used in the directivity control device 210. In short, the position acquisition unit 730 changes a filter used in the directivity control device 210 in accordance with a positional relationship between the speaker unit pair and the position where the user's auditory organ exists to change the region to be audible and the region not to be audible, and it is only necessary to design so that the position where the user's auditory organ exists (the position assumed to exist) becomes the region to be audible, and the position where the user's auditory organ does not exist (the position assumed not to exist) becomes the region not to be audible.

This configuration allows an appropriate region to be the audible region. Note that the acoustic signal reproduced in the present embodiment may be an acoustic signal (heartbeat of the mother's heart, white noise, etc.) for a user (baby).

### Modification Example 1

In this modification example, it is assumed that a speaker unit pair is installed in the backrest portion of the stroller as shown in FIG. 39 and FIG. 40, an attachment such as a buggy board is attached to the outside of the back of the stroller, and a user (infant) rides on the buggy board.

The sound emitted from the backrest portion of the speaker is configured to reach the outside of the stroller. For example, the whole or a part of the member constituting the back of the backrest portion of the stroller is formed into a mesh structure. In addition, for example, a member constituting the backrest portion of the stroller is constituted of a material transmitting sound based on the low frequency acoustic signal.

This constitution allows both the user (baby) riding on the stroller and the user (infant) riding on the attachment such as the buggy board to view the sound based on the acoustic signal. Note that even when there is no attachment such as the buggy board, there is an advantage of easily confirming whether or not the user (guardian) pushing the stroller emits the sound.

### Modification Example 2

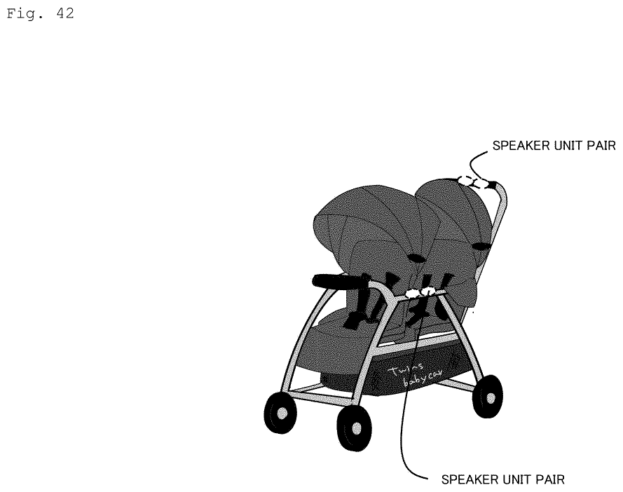

In this modification example, as shown in FIG. 42, a speaker unit pair is installed in the lateral direction on a bar extending between a front seat and a rear seat of a vertical two-person stroller. This constitution allows two users (babies) simultaneously to view by the two speaker pairs. Note that, in FIG. 42, although the two seats face the front, even when the front seat faces the rear and the front seat and the rear seat are arranged so as to face each other, the speaker unit pair is installed in the lateral direction on the bar extending between the front seat and the rear seat of the stroller, and the same effect can be obtained.

### Modification Example 3

As shown in FIG. 42, the speaker unit pair may be installed side by side on the pusher (guardian) side of the bar pushing the stroller. This arrangement allows the user (guardian) pushing the stroller to be targeted. It goes without saying that the speaker unit pairs may be arranged side by side on the pusher (guardian) side of the bar pushing the stroller similarly in the stroller as shown in FIG. 37 and FIG. 38. In addition, the speaker unit pair may be arranged in combination with the speaker unit pair described in the seventh embodiment and all the modification examples. The speaker unit pair is installed in combination for the user (guardian) pushing the stroller and the user (baby) pushing the stroller, so that there is an advantage of easily confirming whether or not the user (guardian) pushing the stroller emits the sound to the user (baby).

### Additional Note

The above description of the embodiments of the present invention is presented for the purpose of illustration and description. There is no intention to be exhaustive and there is no intention to limit the invention to a disclosed exact form. Modifications or variations are possible from the above-mentioned teachings. The embodiments are selectively represented in order to provide the best illustration of the principle of the present invention and in order for those skilled in the art to be able to use the present invention in various embodiments and with various modifications so that the present invention is suitable for deliberated practical use. All of such modifications or variations are within the scope of the present invention defined by the appended claims interpreted according to a width given fairly, legally and impartially.

1. A sound system has at least two speaker unit pairs that comprises a positive speaker comprising no speaker box and a negative speaker comprising no speaker box, the sound system comprising:
processing circuitry configured to:
select any one speaker unit pair in accordance with a position of a user's auditory organ and a position of the speaker unit pair; and
control to emit an acoustic signal (hereinafter referred to as a first acoustic signal) of a predetermined sound source only from the positive speaker of the selected speaker unit pair, and to emit an acoustic signal (hereinafter referred to as a second acoustic signal) having an opposite phase to that of the first acoustic signal only from the negative speaker of the selected speaker unit pair.

2. A sound system has at least three speakers comprising no speaker box, the sound system comprising:
processing circuitry configured to:
select any two speakers in accordance with a position of a user's auditory organ and a position of the speaker; and
control to emit an acoustic signal (hereinafter referred to as a first acoustic signal) of a predetermined sound source only from the selected one speaker, and to emit an acoustic signal (hereinafter referred to as a second acoustic signal) having an opposite phase to that of the first acoustic signal only from the selected other speaker.

3. A vehicle is ridden by a human and moves its position by turning wheels driven by human power or electric power, the vehicle comprising:
a directivity control device configured to comprise processing circuitry configured to implement at least one directivity control unit that executes predetermined signal processing giving directivity to a sound emitted by a speaker unit pair to generate a first processed acoustic signal from an acoustic signal (hereinafter referred to as a first acoustic signal) of a predetermined sound source and to generate a second processed acoustic signal from an acoustic signal (hereinafter referred to as a second acoustic signal) having an opposite phase to that of the first acoustic signal;
a speaker system configured to comprise at least one speaker unit pair that comprises a speaker (hereinafter referred to as a positive speaker) not comprising a speaker box and emitting a sound based on the first processed acoustic signal and a speaker (hereinafter referred to as a negative speaker) not comprising a speaker box and emitting a sound based on the second processed acoustic signal; and
processing circuitry configured to implement a position acquisition unit configured to acquire a position where a user's auditory organ exists or a position where the speaker unit pair exists and select a filter in which directivity of a sound emitted by the speaker unit pair is directed to the acquired position where the user's auditory organ exists, wherein
the directivity control device performs predetermined signal processing by using the selected filter.
